(19) United States
(12) Patent Application Publication
(10) Pub. No.: US 2010/0001703 A1
(43) Pub. Date: Jan. 7, 2010

(54) Programmable Step-Up Switching Voltage Regulators with Adaptive Power MOSFETs

(75) Inventor: Richard K. Williams, Cupertino, CA (US)

Correspondence Address: ADVANCED ANALOGIC TECHNOLOGIES, 3230 Scott Blvd, Santa Clara, CA, 95054, US

(73) Assignee: ADVANCED ANALOGIC TECHNOLOGIES, INC., Santa Clara, CA (US)

(21) Appl. No.: 12/168,561

(22) Filed: Jul. 7, 2008

(51) Int. Cl. G05F 1/62

(52) U.S. Cl. 323/283

(57) ABSTRACT

A step-up switching voltage regulator includes an inductor connected between an input voltage and a node Vx, M low-side switches connected between the node Vx and a ground voltage and N synchronous rectifiers connected between the node Vx and an output node. An interface circuit that decodes a control signal to identify: 1) a subset (m) of the low-side switches, 2) a subset (n) of the synchronous rectifiers, and 3) a reference voltage V_{ref}. A control circuit drives the synchronous rectifiers and low-side switches in a repeating sequence that includes an inductor charging phase where the low-side switches in the subset m are activated to connect the node Vx to the ground voltage; and an inductor discharging phase where the synchronous rectifiers in the subset n are activated to connect the node Vx to the output node.

### RELATED APPLICATIONS

The subject matter of this application is related to the subject matter of a concurrently filed copending application entitled “Programmable Step-Down Switching Voltage Regulators with Adaptive Power MOSFETs.” The disclosure of that application is incorporated herein by reference.

### BACKGROUND OF THE INVENTION

Voltage regulation is commonly required to prevent variation in the supply voltage powering various microelectronic components such as digital ICs, semiconductor memory, display modules, hard disk drives, RF circuitry, microprocessors, digital signal processors and analog ICs, especially in battery powered application likes cell phones, notebook computers and consumer products.

Since the battery or DC input voltage of a product often must be stepped-up to a higher DC voltage, or stepped-down to a lower DC voltage, such regulators are referred to as DC-to-DC converters. Step-down converters are used whenever a battery's voltage is greater than the desired load voltage. Step-down converters may comprise inductive switching regulators, capacitive charge pumps, and linear regulators. Conversely, step-up converters, commonly referred to boost converters, are needed whenever a battery's voltage is lower than the voltage needed to power its load. Step-up converters may comprise inductive switching regulators or capacitive charge pumps.

Operation of Switching Voltage Regulators: Of the aforementioned voltage regulators, the inductive switching converter can achieve superior performance over the widest range of currents, input voltages and output voltages. The fundamental principal of a DC/DC inductive switching converter is based on the simple premise that the current in an inductor (coil or transformer) cannot be changed instantly and that an inductor will produce an opposing voltage to resist any change in its current.

The basic principle of an inductor-based DC/DC switching converter is to switch or “chop” a DC supply into pulses or bursts, and to filter those bursts using a low-pass filter comprising and inductor and capacitor to produce a well behaved time varying voltage, i.e. to change DC into AC. By using one or more transistors switching at a high frequency to repeatedly magnetize and de-magnetize an inductor, the inductor can be used to step-up or step-down the converter's input, producing an output voltage different from its input. After changing the AC voltage up or down using magnetics, the output is then rectified back into DC, and filtered to remove any ripple.

The transistors are typically implemented using MOSFETs with a low on-state resistance, commonly referred to as “power MOSFETs”. Using feedback from the converter's output voltage to control the switching conditions, a constant well-regulated output voltage can be maintained despite rapid changes in the converter's input voltage or its output current.

To remove any AC noise or ripple generated by switching action of the transistors, an output capacitor is placed across the output of the switching regulator circuit. Together the inductor and the output capacitor form a “low-pass” filter able to remove the majority of the transistors' switching noise from reaching the load. The switching frequency, typically 1 MHz or more, must be “high” relative to the resonant frequency of the filter's “LC” tank. Averaged across multiple switching cycles, the switched inductor behaves like a programmable current source with a slow-changing average current.

Since the average inductor current is controlled by transistors that are either biased as “on” or “off” switches, then power dissipation in the transistors is theoretically small and high converter efficiencies, in the eighty to ninety percent range, can be realized. Specifically when a power MOSFET is biased as an on-state switch using a “high” gate bias, it exhibits a linear I-V drain characteristic with a low R_{DS(on)} resistance typically 200 milliohms or less. At 0.5 A for example, such a device will exhibit a maximum voltage drop I_{D}·R_{DS(on)} of only 100 mV despite its high drain current. Its power dissipation during its on-state conduction time is I_{D}²·R_{DS(on)}. In the example given the power dissipation during the transistor's conduction is (0.5 A)²·(0.2Ω)=50 mW.

In its off state, a power MOSFET has its gate biased to its source, i.e. so that V_{GS=}0. Even with an applied drain voltage V_{DS} equal to a converter's battery input voltage V_{batt}, a power MOSFET's drain current I_{DSS} is very small, typically well below one microampere and more generally nanoamperes. The current I_{DSS} primarily comprises junction leakage. So a power MOSFET used as a switch in a DC/DC converter is efficient since in its off condition it exhibits low currents at high voltages, and in its on state it exhibits high currents at a low voltage drop. Excepting switching transients, the I_{D}·V_{DS} product in the power MOSFET remains small, and power dissipation in the switch remains low.

In addition to the main MOSFET switching element, another critical component in switching regulation is the rectifier function needed to convert, or “rectify”, the synthesized AC output of the chopper back into DC. So that the load never sees a reversal of polarity in voltage, the rectifier diode is placed in the series path of the switched inductor and the load thereby blocking large AC signals from the load. The rectifier may be located topologically either in the high-side path somewhere between the positive terminal of the power or battery input and the positive terminal of the output, or on the low-side, i.e. in the “ground” return path. Another function of the rectifier is to control the direction of energy flow so that current only flows from the converter to the load and doesn't reverse direction.

In one class of switching regulators, the rectifier function employs a P-N junction diode or a Schottky diode. The Schottky diode is preferred over the P-N junction because it exhibits a lower voltage drop than P-N junctions, typically 400 mV instead of 700 mV, and therefore dissipates less power. During forward conduction, a P-N diode stores charge in the form of minority carriers. These minority carriers must be removed, i.e. extracted, or recombine naturally before the diode is able to block current in its reverse biased polarity.

Because a Schottky diode uses a metal-semiconductor interface rather than a P-N junction, ideally it doesn't utilize minority carriers to conduct and therefore stores less charge than a P-N junction diode. With less stored charge, the Schottky diode is able to respond more quickly to changes in the polarity of the voltage across its terminals and to operate at higher frequencies. Unfortunately the Schottky has several major disadvantages, the one of which is that it exhibits significant and unwanted off-state leakage current, especially at high temperatures. Unfortunately there is a fundamental tradeoff between a Schottky's off-state leakage and its forward-biased voltage drop.

The lower its voltage drop during conduction, the leakier it becomes in its off state. Moreover, this leakage exhibits a positive voltage coefficient of current, so that as leakage increases, power dissipation also increases causing the Schottky to leak more and dissipate more power causing even more heating. With such positive feedback, localized heating can cause a hot spot to get hotter and “hog” more of the leakage till the spot reaches such a high current density that the device fails, a process known as thermal runaway.

Another disadvantage of a Schottky is the difficulty of integrating it into an IC using conventional wafer fabrication processes and manufacturing. Metals with the best properties for forming Schottky diodes are not commonly available in IC processes. Commonly available metals exhibit too high of a voltage barrier, i.e. too high a voltage drop. Conversely, other commonly available metals exhibit too low of a barrier potential, i.e. suffer from too much leakage.

So despite these limitations, many switching regulators today rely on P-N diodes or Schottky diodes for rectification. As a two-terminal device, a rectifier doesn't require a gate signal to tell it when to conduct or not. Aside from the transient charge storage issue, the rectifier naturally prevents reverse current so that energy cannot flow from the output capacitor and electrical load back into the converter and its inductor.

To reduce voltage drops and improve conduction losses power MOSFETs are also sometimes used to replace the Schottky rectifier diodes in switching regulators. Operation of a MOSFET as a rectifier often is accomplished by placing the MOSFET in parallel with a Schottky diode and turning on the MOSFET whenever the diode conducts, i.e. synchronous to the diode's conduction. In such an application, the MOSFET is therefore referred to as a synchronous rectifier.

Since the synchronous rectifier MOSFET can be sized to have a low on-resistance and a lower voltage drop than the Schottky, conduction current is diverted from the diode to the MOSFET channel and overall power dissipation in the “rectifier” is reduced. Most power MOSFETs includes a parasitic source-to-drain diode. In a switching regulator, the orientation of this intrinsic P-N diode must be the same polarity as the Schottky diode, i.e. cathode to cathode, anode to anode. Since the parallel combination of this silicon P-N diode and the Schottky diode only carry current for brief intervals known as “break-before-make” before the synchronous rectifier MOSFET turns on, the average power dissipation in the diodes is low and the Schottky oftentimes is eliminated altogether.

Assuming transistor switching events are relatively fast compared to the oscillating period, the power loss during switching can in circuit analysis be considered negligible or alternatively treated as a fixed power loss. Overall, then, the power lost in a low-voltage switching regulator can be estimated by considering the conduction and gate drive losses. At multi-megahertz switching frequencies, however, the switching waveform analysis becomes more significant and must be considered by analyzing a device's drain voltage, drain current, and gate bias voltage drive versus time.

The synchronous rectifier MOSFET however, unlike the Schottky or junction diode, allows current to flow bi-directionally and must be operated with precise timing on its gate signal to prevent reverse current flow, unwanted conduction which lowers efficiency, increase power dissipation and heating, and may damage the device. By slowing down switching rates and increasing turn-on delays efficiency can oftentimes be traded for improve robustness in DC/DC switching regulators.

Based on the above principles, present day inductor-based DC/DC switching regulators are implemented using a wide range of circuits, inductors, and converter topologies. Broadly they are divided into two major types of topologies, non-isolated and isolated converters. Isolated converters require transformers that are too large compared to single-winding inductors and suffer from unwanted stray inductances.

Non-isolated power supplies include the step-down Buck converter, the step-up boost converter, and the Buck-boost converter. Buck and boost converters are especially efficient and compact in size, especially operating in the megahertz frequency range where inductors 4.7 μH or less may be used. Such topologies produce a single regulated output voltage per coil, and require a dedicated control loop and separate PWM controller for each output to constantly adjust switch on-times to regulate voltage.

In portable and battery powered applications, synchronous rectification is commonly employed to improve efficiency. A step-up boost converter employing synchronous rectification is known as a synchronous boost converter. A step-down Buck converter employing synchronous rectification is known as a synchronous Buck regulator.

Synchronous Converter Operation: FIG. 1 illustrates two common synchronous switching regulators. As illustrated in FIG. 1A, prior art Buck converter 1 includes a high-side power MOSFET 2, inductor 3, capacitor 4, N-channel synchronous rectifier MOSFET 5 with parallel P-N rectifier 6, and PWM controller 8 with break-before-make circuit 7. Inductor 3, high-side MOSFET 2, synchronous rectifier MOSFET 5, and P-N rectifier 2 share a common node referred to here as the “V_{X}” node, sometimes to in the literature also referred as the Lₓ node.

High-side MOSFET 2 may comprise a P-channel or N-channel MOSFET with appropriate changes in the gate drive circuitry implemented within BBM buffer 7. Another diode (not shown) parasitic to MOSFET 2 remains reverse biased and off throughout regular operation of Buck converter 1. Synchronous Buck regulator 1 may be modified into a non-synchronous Buck regulator or “conventional” Buck converter by eliminating synchronous rectifier MOSFET 5 and substituting a low-loss Schottky diode in place of P-N diode 6.

During regulator operation, the Vₓ node switches between a near V_{batt} potential, whenever high-side MOSFET 2 is on and conducting and slightly below ground, i.e. negative, when MOSFET 2 is off. Specifically when inductor 3 is being magnetized and its current increasing, then Vₓ=(V_{batt}−I_{L}·R_{DS(HS)}), a voltage that depends on the size and on-resistance of MOSFET 2. When MOSFET 2 is off and inductor current is recirculating, i.e. declining, then the Vₓ node voltage is forced below ground by inductor 3. In a conventional Buck or during break-before-make operation in a synchronous Buck, this negative voltage represents the forward bias voltage V_{f} across rectifier diode 6, where Vₓ=−V_{f}. In a synchronous Buck this voltage is the voltage drop across on low-side synchronous rectifier MOSFET 5, or Vₓ=−I_{L}·R_{DS(SR)}.

Using negative feedback V_{FB} from the regulator's output, PWM controller 8 controls the time Vₓ is at the two voltages and thereby controls the current in inductor 3, the charging time of output capacitor 4 and the output voltage. Any decrease in the output voltage V_{OUT} causes the on time of MOSFET 2, i.e. the duty factor D, to increase and drives the output voltage back up to counter the lower output voltage. An increase in the output voltage above a targeted value has the opposite effect, shortening the on-time of MOSFET 2 and reducing the output voltage. In this manner regulation is achieved on a cycle-by-cycle basis, automatically adjusting to hold a specific output voltage within a specified tolerance.

Defining the Buck converter's duty factor D as the time that energy flows from the battery or power source into the DC/DC converter, i.e. during the time that high-side MOSFET switch 2 is on and inductor 3 is being magnetized, then the output-to-input voltage ratio of a Buck converter is proportional to the duty factor D, i.e.

$$\frac{{V}_{out}}{{V}_{i n}} = D ≡ \frac{{t}_{on}}{T}$$

In synchronous Buck converter 1, power losses occur in both main MOSFET 2 and in synchronous rectifier MOSFET 5 comprising both conduction and switching-related losses.

In FIG. 1B, prior art synchronous boost converter 10 includes low-side N-channel power MOSFET 18, inductor 11, capacitor 12, floating synchronous rectifier MOSFET 13, and PWM controller 16 with break-before-make buffer 15. Inductor 11, low-side MOSFET 11, synchronous-rectifier MOSFET 13, and P-N rectifier 14 together share a common node referred to here as the “Vₓ” node, sometimes to in the literature also referred as the Lₓ node.

Floating synchronous rectifier MOSFET 13 may comprise a P-channel or N-channel MOSFET with appropriate changes in the gate drive circuitry implemented within BBM buffer 15. Another diode (not shown) parasitic to MOSFET 18 remains reverse biased and off throughout regular operation of boost converter 1. Synchronous boost regulator 10 may be modified into a non-synchronous boost regulator or “conventional” boost converter by eliminating synchronous rectifier MOSFET 13 and substituting a low-loss Schottky diode in place of P-N diode 14.

During regulator operation, the Vₓ node switches between a near ground potential, whenever low-side MOSFET 18 is on and conducting, and slightly above the output voltage V_{OUT} when MOSFET 18 is off. Specifically when inductor 11 is being magnetized and its current increasing, then Vₓ=I_{L}·R_{DS(LS)}, a voltage that depends on the size and on-resistance of MOSFET 18. When MOSFET 18 is off and inductor current is recirculating, i.e. declining, then the Vₓ node voltage is forced above the output voltage by inductor 11. In a conventional boost or during break-before-make operation in a synchronous boost, this voltage represents the output voltage plus forward bias voltage V_{f} across rectifier diode 14, where Vₓ=V_{OUT}+V_{f}. In a synchronous boost this voltage is the output plus the voltage drop across on floating synchronous rectifier MOSFET 13, or Vₓ=V_{OUT}+I_{L}·R_{DS(SR)}.

Using negative feedback V_{FB} from the regulator's output, PWM controller 16 controls the time Vₓ is at the two voltages and thereby controls the current in inductor 11, the charging time of output capacitor 12 and the output voltage V_{OUT}. Any decrease in the output voltage V_{OUT} causes the on time of low-side MOSFET 18, i.e. the duty factor D, to increase, puts more energy into the inductor, and drives the output voltage back up to counter the lower output voltage. An increase in the output voltage above a targeted value has the opposite effect, shortening the on-time of MOSFET 18 and reducing the output voltage. In this manner regulation is achieved on a cycle-by-cycle basis, automatically adjusting to hold a specific output voltage within a specified tolerance.

Defining the boost converter's duty factor D as the time that energy flows from the battery or power source into the DC/DC converter, i.e. during the time that low-side MOSFET switch 80 is on and inductor 11 is being magnetized, then the output-to-input voltage ratio of a boost converter is inversely proportionate to one minus the duty factor, i.e.

$$\frac{{V}_{out}}{{V}_{i n}} = \frac{1}{1 - D} ≡ \frac{1}{1 - \frac{{t}_{on}}{T}} = \frac{T}{T - {t}_{on}}$$

In synchronous boost converter 10, power losses occur in both main MOSFET 18 and in synchronous rectifier MOSFET 13 comprising both conduction and switching-related losses.

As described, a switching voltage regulator, whether a Buck or boost topology, produces a pre-determined fixed output voltage, regardless of variations in output current, input voltage and temperature. This specification, commonly referred to as a “box” specification is illustrated in graph 20 of FIG. 2. As shown on surface 21, V_{OUT} is regulated for any combination of output current I_{OUT} and input voltage V_{IN}. The output current may vary without warning due to variations in the load current. The input voltage V_{IN} may vary because of voltage fluctuations on the supply line or because of the natural charging and discharging of a battery's voltage V_{batt} in portable application. In this disclosure, the terms V_{IN} and V_{batt} are used interchangeably.

Also part of the box specification for voltage regulation, surface 22 illustrates that V_{OUT} should be regulated despite changes in operating temperature T including any self heating of the converter's components.

### Efficiency Considerations in Switching Regulators:

Maintaining high efficiency over the entire range of the “box” is difficult especially for voltage regulators subjected to wide variations in load current or input voltage. For example, it may be difficult to achieve efficient operation at high load currents when V_{IN} is low because the power-MOSFETs have inadequate gate drive to turn-on fully, i.e. with a low source-drain resistance. Over-sizing the MOSFETs for low input voltage conditions may cause excessive switching losses when the input voltage is high.

Furthermore, sizing a MOSFET to handle a specified high peak current condition results in lower efficiency at low currents, the so called “light load” condition because the power transistors are too large and exhibit high parasitic capacitance contributing to switching related losses. This effect is illustrated in graph 30 of FIG. 3 plotting efficiency versus output current. The normal operating condition curve comprising line segments 32 and 31 illustrate an inverted “U” shape where the efficiency declines at high currents and also at low load currents. Attempts to increase the maximum current exacerbate the efficiency drop 31 in the light load regime. Prior art techniques of varying the frequency or the conducting time of the power MOSFETs to extend the high efficiency range 33 have been developed and are well known but limited in their benefit.

The efficiency challenge is exacerbated by the fact that during in general purpose operation dramatic changes in load current can occur at any time and with no warning, so that the regulator must be prepared to react to the changes at all times even if they occur infrequently. If the regulator cannot react quickly enough, the output voltage will exhibit a spike up or down outside the specified tolerance range of the regulator, potentially resulting in system malfunction or damage to other electronic components.

While the box specification describes the principle of voltage regulation for a pre-determined voltage V_{OUT}, it doesn't preclude the possibility that the desire output voltage may be intentionally changes during operation. For example a load may be powered by a low voltage in certain sleep mode conditions and by a higher voltage when full performance is needed. The problems imposed by operating the switching regulator at different output voltages are many. First the optimization of the regulator's design for one output voltage may differ dramatically for another voltage, affecting efficiency, transient regulation, and even stability. For example, a regulator working well for a 2.5V output may at 3.3V become unstable and oscillate, or may not be able to deliver a regulated 1.1V output under any circumstances. A second problem in changing the output voltage occurs during the dynamic transition during operation, i.e. when the load is subjected to a changing voltage. During the transition, the converter may become unstable or lose regulation temporarily.

To understand the impact of the output current I_{OUT}, the input voltage V_{IN}, and the output voltage V_{OUT} on switching regulator efficiency, the impact of on-resistance and capacitance must be considered.

Power loss in a power MOSFET used in a switching converter comprises a conduction loss P_{cond} during the time the MOSFET is on and conducting, and a switching loss associated with charging and discharging the MOSFET's capacitance. The conduction loss is given by the simple relation

$${P}_{cond} = {I}_{L}^{2} {R}_{DS} \frac{{t}_{on}}{T}$$

where tₒₙ is the time the MOSFET conducts within each cycle T. On-resistance is proportional to the inverse of the gate voltage, i.e.

$${R}_{DS} ∝ \frac{1}{{V}_{GS} - {V}_{t}}$$

so that higher gate drive voltage results in lower resistance and lower conduction losses

Switching losses are more complex to model but can be simplified under certain conditions. Capacitances shown in schematic 80 of FIG. 4C include the gate-to-source capacitance 83, the non-linear gate-to-drain capacitor 82 and the drain to source capacitor 84. Specifically, at low voltages switching losses are dominated by gate capacitance driving losses P_{drive}. Since the gate capacitance includes both gate-to-source and nonlinear gate-to-drain device related capacitances it is inconvenient to characterize the large signal gate drive losses of a power MOSFET using capacitance. Instead, gate charge Q_{G}, a physically conserved quantity, offers a more accurate description of the device's drive requirements.

Gate charge is measured by driving the gate of a MOSFET with a current source and its drain with either a current source or a load and a voltage source. The resulting waveforms are shown in graph 40 of FIG. 4A. The abscissa is essentially time, but since the gate is being driven by a constant current, then since Q_{G}=I_{G}Δt, the graph is re-plotted with charge in units of coulombs on the x-axis.

The curves illustrate two voltages, the drain voltage V_{DS} on the right ordinate axis, and the gate voltage V_{GS} on the left. Starting at zero gate charge, the current source is turned on and begins charging the MOSFET's gate charging both gate-to-drain and gate-to-source capacitances. Accordingly, the gate voltage 45 ramps linearly with time while the drain voltage 41 remains constant at V_{DD}. In region 42 the drain voltage begins to drop so that the current supplying the gate is used to supply only the gate-to-drain capacitance. As a result the gate voltage hits a plateau 46 until the drain voltage slope drops as it reaches its voltage asymptote 43 after which the gate voltage returns to its linear ramp 47.

During the transition 42, the power MOSFET operates in its saturation region and exhibits voltage gain making the gate-to-drain feedback capacitance C_{GD} appear larger than it is. In small signal applications, this effect is known as the Miller effect as illustrated in equivalent circuit 85 of FIG. 4D. As shown the gate-to-drain capacitance 88 is split into two elements in the hybrid-π circuit model shown, namely an output capacitance approximately equal to C_{GD} itself, and an input capacitance of magnitude A_{V}C_{GD} where A_{V} is the circuit's voltage gain. The input capacitance Cᵢₙ is then the sum of C_{GS} and A_{V}C_{GD} and is often dominated by the gate-to-drain component. In the gate charge curve, the gain factor and capacitances are continuously changing. The curve integrates all these effects as charge, not capacitance, and therefore is correct at any operating point.

To fully turn on the device, the MOSFET must be driven into its linear region. At point 44, the device is on with a drain voltage of magnitude I_{L}R_{DS(on)} and with a gate voltage V_{GS} corresponding to point 48. The total loss to drive the gate to this point then discharge it is given by

$${P}_{drive} = \frac{{Q}_{G} {V}_{GS}}{T} = {Q}_{G} {V}_{GS} f$$

Higher gate voltages therefore increases gate drive losses. Since higher gate drive reduces conduction losses, an unavoidable tradeoff exists between conduction loss and gate drive loss. This point is illustrated in FIG. 4B by re-plotting the prior graph with the x-axis representing gate bias V_{GS} and the y-axis including both gate charge Q_{G} and on resistance R_{DS}. The transposed gate charge curve is shown with off region 61, saturation region 62 and linear region 63 while the on resistance declines rapidly 64 at the edge of saturation stabilizes in its linear region 65 and finally hits an asymptote 66.

The total power loss is then the sum of these two losses, the conduction loss and the gate drive loss which can be expressed by the relation

$${P}_{loss} = {I}_{L}^{2} {R}_{DS} \frac{{t}_{on}}{T} + {Q}_{G} {V}_{GS} f$$

This relation is plotted as a function of gate drive in curves 69, 70 and 71 for increasing frequencies. Each curve exhibits thee regions. For example in region 67 the overall losses decline because the reduction in on-resistance is hyperbolic while the increase in gate charge is only linear. In region 69 the losses increases in proportion to the gate drive because the on-resistance is constant. In between at region 68 the MOSFET is biased at an optimum gate potential to minimize losses. If the frequency is changed however, as in curves 70 and 71, the bias point for minimum loss changes.

These losses occur in both the main MOSFET and in the synchronous rectifier. The main switch comprises the high-side MOSFET in a Buck regulator and the low-side MOSFET in a boost regulator. Since the main switch has a duty factor D=tₒₙ/T, then the above equation becomes

Pₘₐᵢₙ=I_{L}²R_{DS}D+Q_{G}V_{GS}f

The synchronous converter operates out of phase so

P_{SR}=I_{L}²R_{DS}(1−D)+Q_{G}V_{GS}f

but still exhibits the same gate drive loss. The total MOSFET power losses are then the sum of the main and synchronous MOSFET losses, i.e.

Pₜₒₜₐₗ=Pₘₐᵢₙ+P_{SR}

So in a synchronous converter the gate drive losses are always occurring in both MOSFETs all the time. In synchronous Buck converter 1 although conduction losses alternate between main MOSFET 2 and synchronous rectifier MOSFET 5, both MOSFETs exhibit gate drive losses in every switching cycle. Similarly, in synchronous boost converter 10 conduction losses alternate between main MOSFET 18 and synchronous rectifier MOSFET 13 with both MOSFETs exhibiting gate drive losses in every switching cycle.

Minimizing the overall loss in synchronous converter 1 or 10 therefore involves making choices as to the size, resistance and capacitance of both the main and synchronous rectifier MOSFETs during the converter's design. Since gate charge is proportional to gate width, it is desirable to minimize the MOSFETs' gate widths to reduce drive losses. But since R_{DS} is inversely proportional to gate width that method results in increased conduction losses. This tradeoff can be more clearly expressed by rewriting the above equations in terms of the gate width W. The bracketed terms [R_{DS}W] and [Q_{G}/W] describe the performance of a given technology MOSFET and are process and design specific.

$${P}_{main} = {I}_{L}^{2} \frac{[ {R}_{DS} W ]}{{W}_{main}} \frac{{t}_{on}}{T} + [ \frac{{Q}_{G}}{W} ] {W}_{main} {V}_{GS} f$$

Increasing the main MOSFET's gate width Wₘₐᵢₙ lowers the losses in the first term, i.e. the conduction loss, and increases the losses in the second term, the gate drive loss component. In between is a gate width with the minimum power loss. So for any given load current, an optimum gate width transistor exists that minimizes the switching regulator's overall losses. A similar equation can be developed for the synchronous rectifier MOSFET with an on time (T−tₒₙ).

$${P}_{SR} = {I}_{L}^{2} \frac{[ {R}_{DS} W ]}{{W}_{SR}} \frac{( T - {t}_{on} )}{T} + [ \frac{{Q}_{G}}{W} ] {W}_{SR} {V}_{GS} f$$

For any given inductor current I_{L} an optimum gate width W can be calculated for the converter's main MOSFET and in similar fashion for a converter's synchronous rectifier MOSFET. Unfortunately in conventional power MOSFETs once the gate width is chosen and the device is design in the integrated circuit, it cannot be changed. In such a design, the MOSFET operates optimally for only very narrow range of currents.

Even if hypothetically somehow the size of the MOSFET could be adjusted dynamically to always maintain the optimum efficiency and to minimize gate drive losses, the inductor current must be known a priori, before the MOSFET size is adjusted. Adjusting the size of the MOSFET in response to changing current, i.e. after the current has changed, is too late. If the current suddenly increases while a small gate width MOSFET is being used, during the finite time it takes to measure the current and dynamically adjust the MOSFET's size, the output voltage will drop and unacceptably poor regulation will result. Poor transient response means without a method of “predicting” the current, the converter cannot be considered as a voltage regulator. Existing switching regulators are not able to adaptively maximum their efficiency relative to changing currents.

Another variable affecting a converter's efficiency is the relative on time tₒₙ of the main MOSFET compared to the on time (T−tₒₙ) of the synchronous rectifier. Within any duration T, the on times of the main MOSFET and the synchronous rectifier MOSFET are set by the voltage conversion ratio V_{OUT}/V_{batt}. While the output voltage may be fixed to a specified value, the input voltage can fluctuate and affect the optimum tₒₙ time.

As described previously, a switching voltage regulator operates at maximum efficiency at a particular bias condition that minimizes the power loss for both gate drive losses and conduction losses simultaneously. The bias conditions include any combination of input voltage, load current, gate drive, and switching frequencies. In normal applications however, voltage current and temperature vary naturally and their influence on converter efficiency cannot be avoided. For a given converter design, the optimum bias conditions therefore represents a multidimensional response surface and not a single operating point.

Moreover, since most of these parameters vary during operation, especially load current, input voltage and temperature; then a power supply designer must make certain compromises to achieve the best overall converter efficiency by sacrificing the efficiency of operation under conditions that occur less often, either infrequently or of shorter duration. One way to guarantee performance is to limit the range of converter operation through its specification, e.g. limiting a voltage regulator's use to the box specification shown in FIG. 2. But even operating within this restricted range of conditions, significant performance compromises exist.

Other design parameters which appear to be within the power supply circuit designer's control in fact are not, either because it is impractical to do so or because it may adversely affect other electrical circuitry in the system being regulated. For example, during normal full load current operation, varying the switching frequency f of a converter is generally considered unacceptable, especially in communication devices such as cell phones, because it produces a varying and unpredictable noise spectrum, difficult to filter or suppress. Variable frequency operation is acceptable at low load currents only because the amount of interference it generates is relatively small compared to operating at higher currents.

Optimizing gate drive is also problematic. The gate drive circuitry for the power MOSFETs in a switching regulator normally charge and discharge a MOSFET's gate capacitance rail-to-rail to whatever supply voltage is powering the gate buffer. Only two voltages are generally available to drive the gate buffer, the input voltage or the output voltage. Neither of these voltages is necessarily an optimum voltage for achieving maximum switching converter efficiency.

Moreover the input voltage varies over time so the efficiency will unavoidably vary with the input. For example in a battery powered application the input voltage may be too high in voltage for optimum operation when the battery input is in its fully charged condition, leading to unwanted and excessive capacitive gate drive losses. When the battery is nearly discharged, the voltage may be inadequate to achieve full channel conduction in the MOSFET leading to high resistance and excessive conduction losses.

Using another voltage regulator, e.g. a linear regulator, to power the MOSFET gate buffer may eliminate the voltage dependence of gate drive losses, but this regulator also suffers voltage dependent power losses. In fact in the case of the linear regulator, the losses of the regulator powering the gate buffer can be as great as the power saved by the improved gate drive.

Power MOSFETs with Varying Gate Width and Problems Thereof

If changing gate drive and adjusting frequency are not available to optimize the converter's performance and load current, input voltage and temperature are externally imposed conditions related to the regulator's application the only other variable having a major impact on a switching converter's efficiency is the size, i.e. the gate width, of the power MOSFETs. This concept, referred to herein as a variable gate width switching converter, is described in prior art U.S. Pat. No. 5,973,367 by Richard K. Williams and in another implementation in U.S. Pat. No. 7,026,795 by John So.

The premise of both techniques is that an optimum gate width exists for any given output current to maximize the efficiency of a switching regulator and that by adjusting the gate width dynamically in response to changing currents, the regulator can be adjusted to always operate at its point of maximum efficiency. For example at high currents a large power MOSFET is used offering low on resistance and low conduction losses while at low currents where conduction losses are less critical, the circuit is reconfigured to use a smaller power MOSFET offering lower input capacitance, gate charge and drive losses.

While this premise is true in theory, in practice a dynamic regulation problem results. The practical drawback of this technique is substantial and has essentially prevented the successful commercialization and any practical use of the technique.

In one problem scenario, unpredictable changes in load current result in momentary loss of voltage regulation, potentially causing system failure, device failure, or both. To analyze this failure, two scenarios must be considered, a step-function decrease in load current and a step-function increase in load current.

In the first case, a large-gate-width power MOSFET stably operating at high currents suddenly and without warning experiences a substantial decrease in load current. In time, the system detects the lower load current and portions of the power MOSFET are shut off, i.e. no longer switching, thereby reducing the gate drive current and gate drive associated power loss. After some time the gate width adjusts to the optimum condition and efficiency improves. In the event the feedback and control circuit of the regulator reacts too slowly to the rapid drop in load current, for some duration the entire full-size power MOSFET remains switching. Because the switching device is unnecessarily large, a temporarily condition occurs exhibiting lower overall efficiency. The loss of efficiency occurs because the gate drive losses remain fixed in absolute power, but the delivered power to the load drops, so that the gate drive loss increases on a percentage basis lowering the converter's overall efficiency.

Despite the momentary loss of efficiency, the converter still accurately regulates the desired output voltage. Eventually, the circuit detects the lower current, the control circuit reacts, and the device size is reduced to a small gate width with less input capacitance, thereby improving the converter's overall efficiency. So using the variable gate width technique, a decrease in load current does not cause any problem in accurately maintaining a regulated voltage, just a momentary period of lower efficiency.

In the other case, i.e. a step-function increase in load current, serious performance deficiencies can occur. Specifically if the load current increases dramatically and without warning, the prior-art variable-gate-width switching regulator may not have time to react, the voltage falls outside the specified range, and regulation is lost. In such a variable-width switching regulator operating at a low load current for an extended duration, for example, the prior art converter senses the low load current condition and adjusts its gate width to some minimum value. If at a subsequent time, the load current suddenly increases, the regulator's pulse width control will attempt to increase the inductor's current by jumping to a maximum duty cycle condition. But because the MOSFET's gate width has been reduced to a small W during the prior condition, its resistance is too high to rapidly increase the inductor's current.

Even if in the next cycle the MOSFET's gate width is increased, it may be too late to increase the inductor's current sufficiently to avoid a voltage transient from occurring on the regulator's output. If the MOSFET gate width is not increased sufficiently, another cycle will occur before the circuit reacts appropriately. In fact, the converter may require many cycles before it finally adjusts the MOSFET to an adequate size to carry the necessary current to react to the load transient. During this time, the voltage regulation suffers.

Being able to adjust a MOSFET's size to reduce gate drive losses at lighter load conditions can improve efficiency but only by sacrificing transient regulation. In extreme cases, the degradation in regulation accuracy may in fact render the converter unusable. In other words, the prior-art variable-width switching regulator is incapable of regulating a constant voltage over a range of load currents because it cannot react quickly enough to maintain regulation. It therefore does not meet the box specification of FIG. 2.

Prior art attempts to vary a power MOSFET's gate width in response to changing load currents in a fixed-output voltage switching voltage regulator resulted in poor or unacceptable voltage regulation of load transients. Similarly, using the prior art techniques to optimize efficiency in a switching regulator with a variable output suffer the same regulation issues as fixed output regulators. In either case, the converter does not have adequate time to react to changing load currents and regulation suffers. So while the converter's slow response results in poor transient regulation, the unpredictability of the load current is the condition that causes the problem.

In conclusion, today's varying the gate width of the power MOSFETs in a switching regulator helps reduce switching losses and widen the range of currents with conversion efficiency but at the expense of suffering poor regulation. As a result such wide-efficiency converters have not been commercially successful.

Dynamic and Programmable Biasing and Problems Thereof

Another approach to improving the efficiency of a switching regulator is to change its electrical bias and operating conditions in response to changing load currents.

Returning to FIG. 3, the boost in efficiency illustrated by curve 33 is achieved by variable frequency operation. In such converters the switching frequency of the converter is lowered as the measured load current declines. The change can occur gradually or be digital in nature—switching into a different mode of operation optimized for “light load” when a certain threshold condition is met. In some cases the switching converter completely stops switching until the output voltage sags to some predetermined voltage condition, then switching resumes. Like a thermostat in a heating system, the switching regulator runs till the output reaches some upper limit, then shuts off until the output drops to some lower threshold, then turns on again.

Aside from its switching frequency, other parameters can be dynamically adjusted in response to sensing the load current. For example, as the load current declines, bias currents in analog circuitry can also be decreased to burn less power, lowering quiescent current and further extending the range of decent efficiency.

Considering the abscissa of graph 30 is not linear, but illustrates the logarithm of the converter's output current, then curve 33 represents a substantial improvement over several decades of current.

Unfortunately, electrical bias techniques to improve light load efficiency suffer similar problems to the variable gate width MOSFET, including increased ripple, variable frequency noise, and poor load transient response. Biased at low currents, a comparator suffers slow slew rates, op amps exhibit low bandwidths, and the converter needs time to respond to any significant change in the load or input condition. Dynamically changing switching frequencies to control switching losses creates noise spectra almost impossible to filter out of sensitive communication circuitry.

Even worse, new applications demand that the output voltage of a switching regulator be dynamically programmable in real time under the control of a microprocessor, digital controller, or baseband processor. Dynamically adjusting the output voltage of a switching regulator greatly exacerbates all the aforementioned problems and changes the box specification illustrated in FIG. 2 into a four-dimensional graph.

It is anticipated that the number-of-applications requiring programmable output voltages will continue to expand. Today's microprocessors already operate using dynamically programmable voltages. The newest 3G cell phones offering high speed packet communication utilize radio-frequency power-amplifiers requiring dynamic supply voltages, lowering their supply voltage during voice communication and raising it only during high-speed data transfer.

The Problem of Reaction Time

In every aforementioned prior art method attempting to widen the range of a switching regulator's efficiency, especially for light load operation, the converter's poor regulation is a problem of reaction time. A switching regulator operating to save power takes a long time to sense and react to changes, especially changes in load current. Obviously a switching voltage regulator that cannot react to unpredictable changes in load current has little or no utility.

But part of the problem lies in the belief that load current is unpredictable, that it must be sensed to know what it is. Implicit in the box specification for a voltage regulator is the assumption that the current cannot be anticipated and therefore must be sensed. And to react quickly to a sensed condition, a switching converter must draw substantial power. Together these facts suggest there is fundamental tradeoff between efficiency and transient regulation, a tradeoff that only worsens at low load currents.

The load current sensing and transient regulation problem only worsens if the output voltage is also allowed to vary dynamically too. In such a case, regulation accuracy depends on at least four state variables—load current, input voltage, output voltage, and temperature. Quickly reacting to changes in load current without drawing any quiescent current or lowering a converter's efficiency is particularly daunting if the output voltage is allowed to dynamically change too.

So what is needed is a high-efficiency programmable synchronous switching regulator able to accurately vary and regulate its output voltage while anticipating or predicting the resulting load current, and by adjusting bias currents, power MOSFET gate widths, and switching frequency accordingly to provide an optimum tradeoff between efficiency and accurate regulation of its output over changing load currents.

### SUMMARY OF THE INVENTION

An embodiment of the present invention provides a programmable step-up switching voltage regulator with predictive control and adaptive power MOSFETs capable of adjusting its operation to simultaneously supply the requisite load current, maintain tight regulation, and achieve peak efficiency. Predictive control is achieved by anticipating, i.e. predicting, the load current based on predetermined variables including the regulator's programmed output voltage, and in tandem by adjusting the regulator's operation and power MOSFET gate widths for maximum efficiency or performance at the expected current.

In one embodiment the electrical load exhibits a known monotonic current-voltage characteristic, and the same control input used to set the regulator's output voltage is also used to adjust the power MOSFETs' gate widths for maximum regulator efficiency.

In another embodiment, allowing for natural statistical variance, the current-voltage characteristic of the load is programmed or stored in memory of the switching regulator so that the regulator's output voltage provides a reasonable estimate of the maximum load current under that voltage condition. The predicted current is also used to look-up and set the optimum gate widths of the regulator's switching power MOSFETs, and optionally used to set the operating frequency and internal bias currents appropriately.

For one implementation, an inductor is connected between an input voltage and a node Vx. A series of M low-side switches are connected in parallel between the node Vx and a ground voltage. A series of N synchronous rectifiers are connected between the node Vx and an output node. A control circuit is connected to drive the synchronous rectifiers and low-side switches in a two phase repeating sequence that includes an inductor charging phase and an inductor discharging phase. During the inductor charging phase, a subset (m) of the low-side switches are activated (i.e., enabled or turned ON). This causes current to flow from the supply voltage through the inductor to ground. During the inductor discharging phase, a subset (n) of the synchronous rectifiers are activated to connect the node Vx to the output node. This causes current to flow from the supply voltage to the output node via the inductor.

The control circuit monitors the voltage at the output node and compares that voltage (or a voltage proportional to the output voltage) to a reference voltage V_{ref}. Based on this comparison, the control circuit adjusts the relative times of the inductor charging and discharging phases to maintain the output voltage within regulation.

An interface circuit monitors a control signal input to the switching voltage regulator. The content of that signal, which may be digital or analog is used to derive the reference voltage V_{ref} which is used, in turn to define the output voltage of the switching regulator. The switching regulator is used in combination with electrical loads that exhibit known, or reasonably known, voltage-current dependencies. Thus, changing the reference voltage V_{ref} and the output voltage changes the current required by the load in a known way. Based on this known dependency, the interface circuit selects the subsets n and m to most efficiently provide the required current for the particular output voltage being specified.

In another embodiment, the switching frequency of the converter and/or various bias currents used in internal analog circuitry such as voltage references, comparators, and amplifiers can also be adjusted in accordance with the interface control signal and known current dependency of the load. In general, the switching frequency and bias currents are programmed to decrease in proportion to or corresponding with lower output voltages and lower output currents. The frequency or bias currents may scale with the output current by some mathematical function or alternately be manifested as on or more discrete steps in magnitude.

Several different configurations for the low-side switches and synchronous rectifiers are supported. One such configuration provides two low-side switches and two synchronous rectifiers. One low-side switch and one synchronous rectifier operate at all load conditions and are augmented by the second low-side switch and synchronous rectifier at high load conditions. This is particularly useful when the second or auxiliary low-side switch and synchronous rectifier are wider (and thus able to handle more current) than the primary low-side switch and synchronous rectifier.

For another configuration, three, four or even more low-side switches are paired with a similar number of synchronous rectifiers allowing the additional pairs of low-side switches and synchronous rectifiers to be added on as-needed basis. The low-side switches and synchronous rectifiers in this type of configuration may be equal width or have different widths and current handling abilities.

For still another configuration, each synchronous rectifier (except the narrowest) is twice as wide as the next widest synchronous rectifier and each low-side switch (except the narrowest) is twice as wide as the next widest low-side switch. Thus, if the narrowest synchronous rectifier is one unit wide, the next synchronous rectifier would be two units wide and the next synchronous rectifier would be four units wide (the low-side switches would be configured in a similar way). In this type of configuration, any subset of synchronous rectifiers and low-side switches may be selected (i.e., there is no pair that is always active). This allows the switching regulator with J pairs of synchronous rectifiers and low-side switches to operation at 2^{J}-1 different width configurations (e.g., for three pairs, operation at widths one, two, three, four, five, six and seven).

It should be noted that it is also possible to use different numbers of low-sides switches and synchronous rectifiers and it is also possible to pair a series of low-side switches with diodes acting in place of the synchronous rectifiers.

Also the number of combinations of gate widths for the low side MOSFET and for the synchronous rectifier MOSFET are not necessarily the same.

### BRIEF DESCRIPTION OF THE DRAWINGS

FIG. 1 Conventional prior-art switching regulators (A) synchronous Buck schematic (B) synchronous boost schematic

FIG. 2 Box specification of a switching voltage regulator

FIG. 3 Current dependence of switching regulator

FIG. 4 Components of power loss in power MOSFETs (A) gate charge curve (B) gate-drive dependence of power loss components (C) MOSFET parasitic capacitance (D) hybrid-pi model

FIG. 5 Powering electrical loads with predictable currents (A) monotonic voltage dependent load current (B) LED driver (C) series LED driver (D) RF power amplifier (E) load with known I=f(V)

FIG. 6 Programmable boost voltage regulator with dual-state adaptive power MOSFET

FIG. 7 High-current operation of programmable boost voltage regulator with dual-state adaptive power MOSFET (A) equivalent DC circuit (B) equivalent AC circuit (C) simplified AC circuit

FIG. 8 Low-current operation of programmable boost voltage regulator with dual-state adaptive power MOSFET (A) equivalent DC circuit (B) equivalent AC circuit (C) simplified AC circuit

FIG. 9 Efficiency characteristic of programmable boost voltage regulator with dual-state adaptive power MOSFET

FIG. 10 Operational algorithm of programmable boost voltage regulator with dual-state adaptive power MOSFET

FIG. 11 Step load response of programmable boost voltage regulator with dual-state adaptive power MOSFET

FIG. 12 Schematic of programmable boost voltage regulator with multi-state adaptive power MOSFET

FIG. 13 Code dependence of programmable boost voltage regulator with multi-state adaptive power MOSFET (A) constant width increments (B) non-linear width increments

FIG. 14 Efficiency characteristic of programmable boost voltage regulator with multi-state adaptive power MOSFET

FIG. 15 Code and duty factor dependence of programmable boost voltage regulator with multi-state adaptive power MOSFET (A) constant width increments for varying duty factors (B) reciprocal D dependence of synchronous rectifier (C) quantized duty factor dependent code

FIG. 16 Control of programmable voltage switching regulator using digital-controlled reference voltage with digital adaptive gate width control

FIG. 17 Alternate digital controller implementations of programmable voltage switching regulator with digital adaptive gate width control (A) direct D/A control of error amplifier (B) digital control of resistor D/A resistor ladder

FIG. 18 Programmable voltage switching regulator with analog control (A) direct A/D converter gate width control (B) A/D converter output.

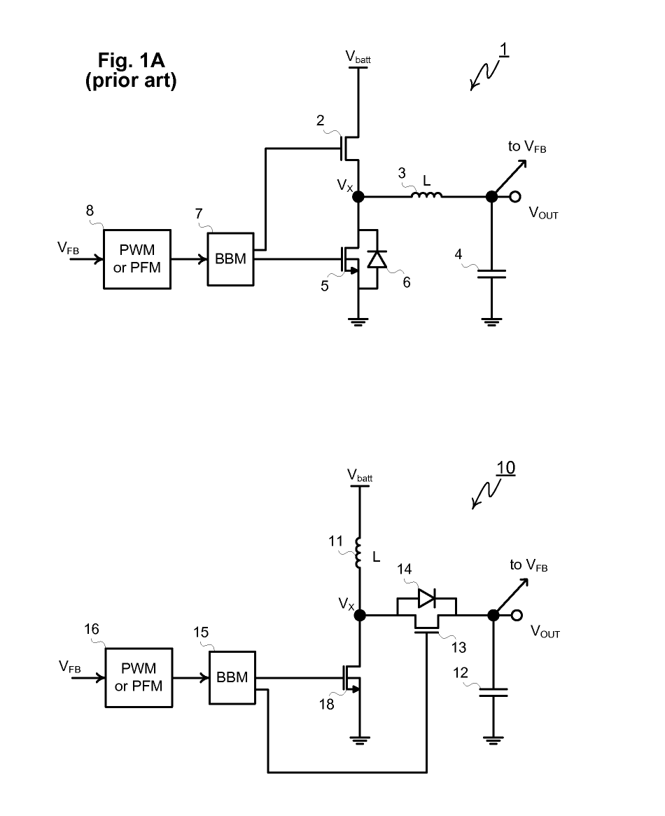

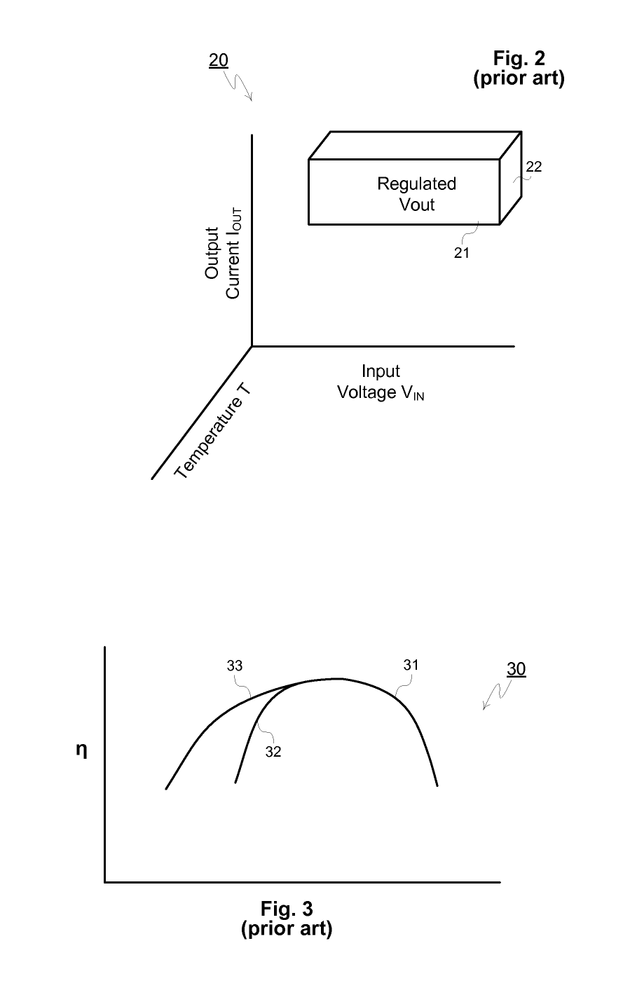

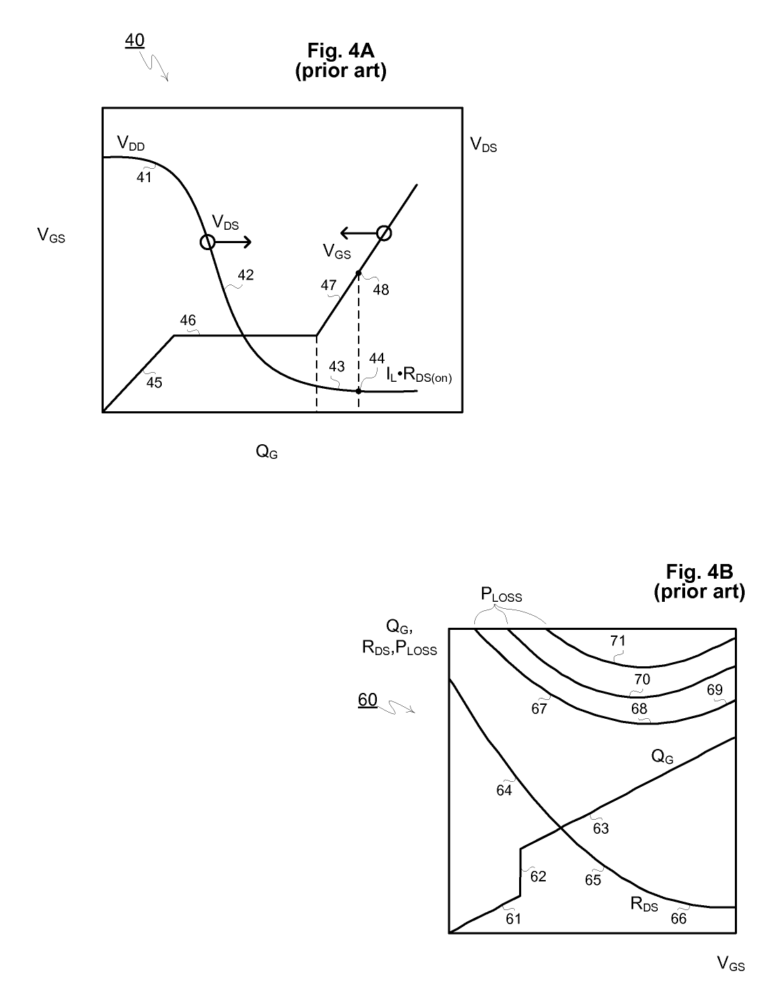

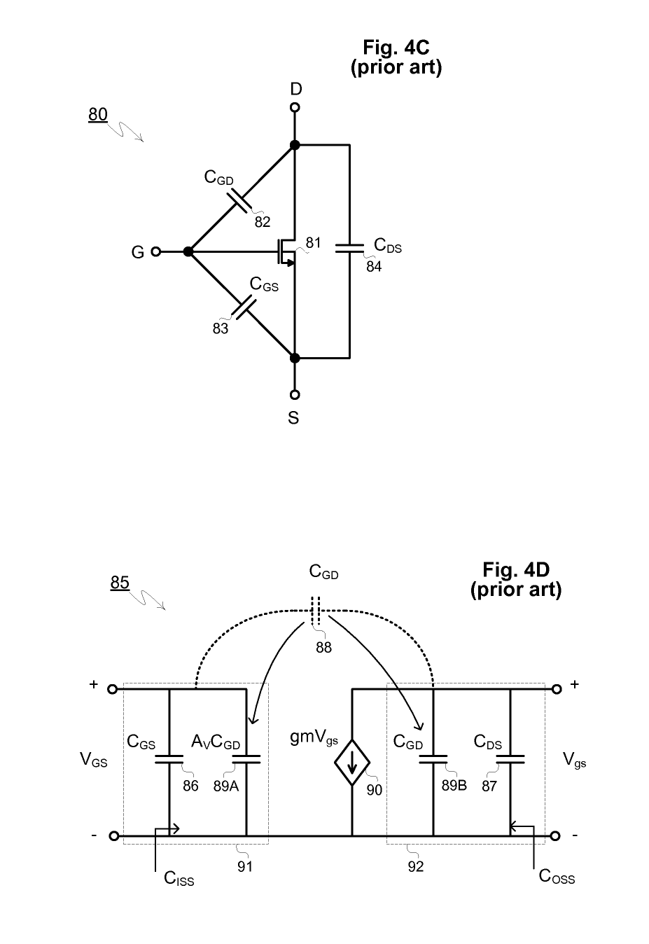

### DETAILED DESCRIPTION OF THE PREFERRED EMBODIMENTS

A switching voltage regulator with adaptive power MOSFET and variable gate width control is disclosed herein, comprising a programmable variable output voltage powering a load with a known current-voltage characteristic. The converter, in combination with any load where the current primarily or exclusively depends on its output voltage, i.e. where I_{OUT}=f(V_{OUT}), exhibits a higher efficiency over a broader range of currents than a conventional converter designed to a box specification. The load specific regulator, to within some tolerance, is able to predict the load current a priori through its programmable output voltage and to dynamically adjust its gate width to maximize its conversion efficiency and accommodate the requisite current before it occurs.

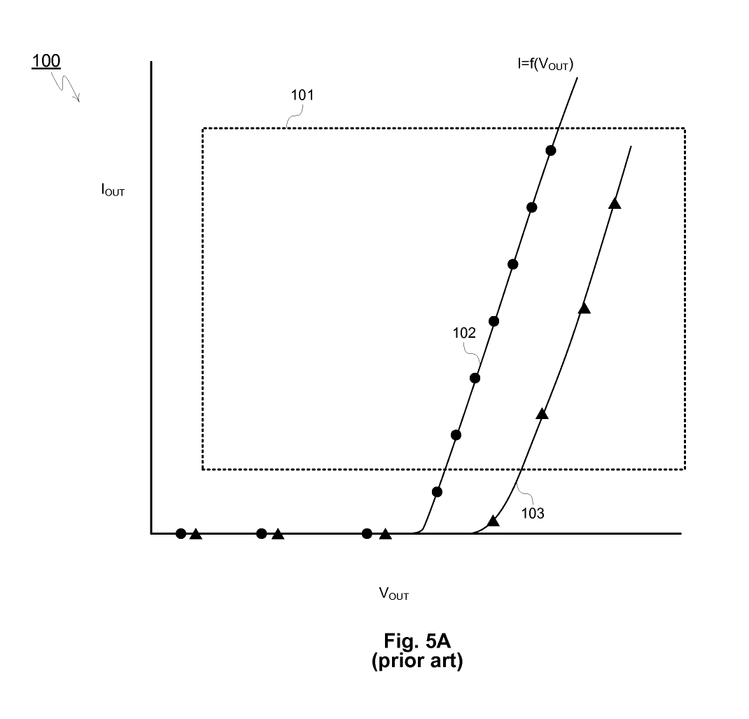

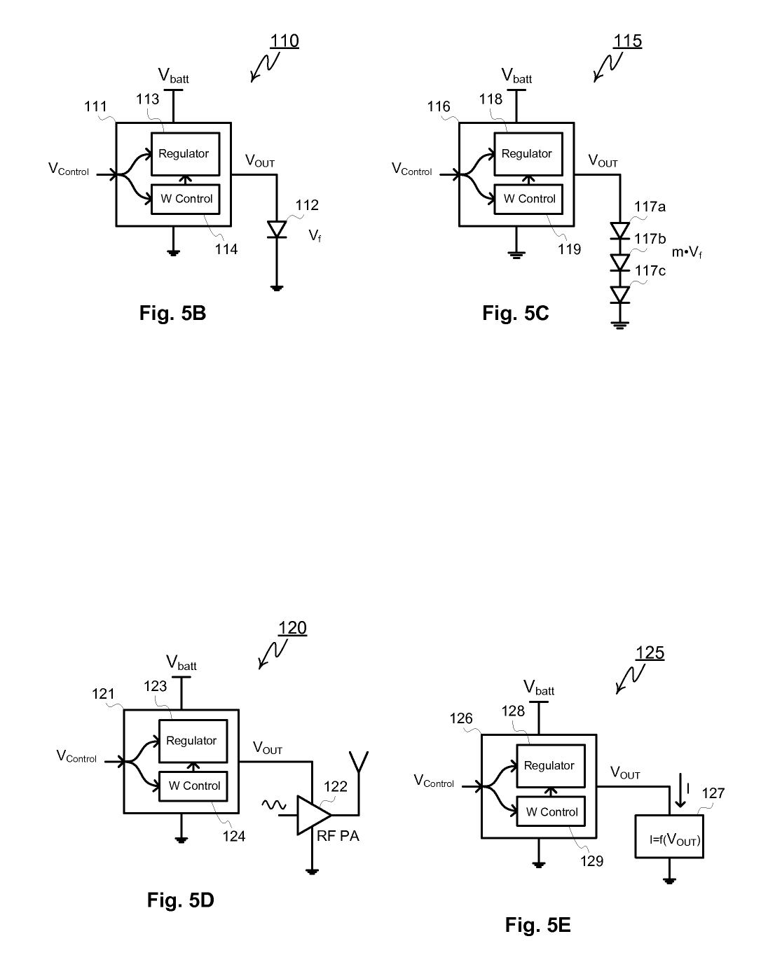

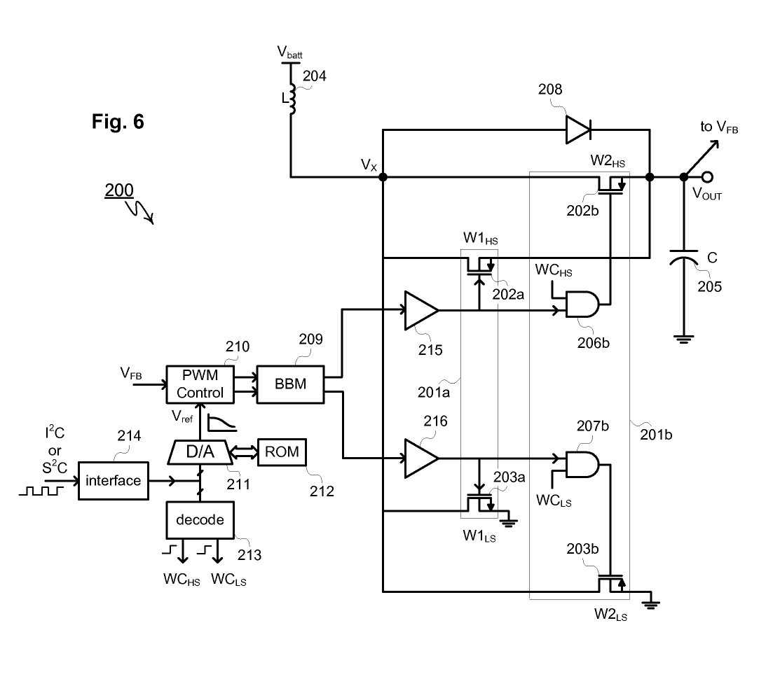

For example, as shown in graph 100 of I_{OUT} versus V_{OUT} in FIG. 5A, load 102 exhibits a linear dependence of current with voltage and can be represented mathematically by the equation of a straight line I_{OUT}=(V_{OUT}−V_{load})/R_{load} for any output voltage V_{OUT} greater than some minimum load voltage V_{load} representing the onset of conduction. The term R_{load} represents the reciprocal of the slope of line 102. In such a case, by programming the regulator's output voltage V_{OUT} to some specific value V′_{OUT}, a known load current I′_{OUT} results. The regulator's output may be controlled by a V_{control} signal comprising an analog signal or a digital code corresponding to a desired output voltage.

The current-voltage load characteristic as shown in the case of curve 103 may not be linear but may comprise any mathematical relation including quadratic, exponential, logarithmic or power law functions. In any event, the load characteristic 102 or 103 is substantially smaller than normal box specification 101, and where the current and voltage are correlated, i.e. interdependent. In a preferred embodiment, an electrical load exhibits a specific or narrow range of current I_{OUT} corresponding to a given applied bias V_{OUT}. While the load current may vary from load-to-load, the current-voltage characteristics of a specific load should be well defined and preferably monotonic to avoid any oscillation risks that may occur with loads having negative resistance.

While the load current may vary in response to other variables, in a preferred embodiment it strongly depends on V_{OUT} and to a lesser degree on any other influences. If it does depend on other variables, e.g. temperature, it is preferable that those variable change slowly in comparison to V_{OUT}, so that the parameter may be measured or communicated through the interface at a low data rate and may be treated as a “quasi-static” variable in any calculation.

In one embodiment of this invention, an electrical load with a well-defined monotonic I-V characteristic illustrated in FIG. 5B comprising circuit 110 includes programmable voltage regulator 111 with forward-biased light emitting diode 112. The LED has a well defined conduction characteristic with current as a function of the diode's forward voltage V_{F}. Typical forward voltages range from 3V to 4V depending on the LED's color and construction. The LED's brightness is proportional to its conduction current. By varying the bias voltage across diode 112 in response to control signal V_{control}, the LED's current and brightness can be controlled. Non-lithium-ion battery chemistries such as alkaline and nickel-metal-hydride, i.e. NiMH, have cell voltages around 1V. Even connecting two or three cells in series, the voltage needed to drive one blue or green LED is greater than the battery. In such a case a step up converter is required.

Voltage regulator 111 comprises a switching regulator 113 with an adjustable output voltage and adaptive W-control circuitry 1 14 to control the size, i.e. the gate width, of the converter's power MOSFETs. The V_{control} signal, which is used to set the converter's output voltage, may comprise an analog signal or a digital code corresponding to a desired output voltage. To maximize converter efficiency, the V_{control} signal is also in a preferred embodiment used to determine, i.e. to set, the width of the power MOSFETs comprising voltage regulator 111. The same signal may be used to set bias currents and the converter's switching frequency if so desired. Since the voltage programmable switching regulator adjusts its operating characteristics, i.e. adapts its gate width, to the same V_{control} control signal controlling the regulator's programmable output voltage and the load current, then switching regulator 111 is herein referred to as an “adaptive” switching regulator.

In circuit 115 of FIG. 5C voltage regulator 116 made in accordance with this invention powers a string of m LEDs. In the example shown m=3 comprising series connected LED's 117A, 117B, and 117C. The total voltage across the diodes is the sum of the individual forward voltages, i.e. Σ V_{Fm}≈mV_{F}, approximately m times the forward voltage of a single LED. The voltage V_{OUT} determines the current flowing in the series connected diodes. Since the same current I_{OUT} flows in all three LEDs, the brightness of 117A, 117B, and 117C are equal. By varying the bias voltage across the series connected diode in response to control signal V_{control}, the LEDs' current and brightness can be controlled. If two or more LEDs are connected in series, their voltage at the onset of conduction and light emission is well above the voltage of a single cell lithium ion battery. In such a case a boost converter is required to power the LED string.

Voltage regulator 116 comprises a switching regulator 118 with an adjustable output voltage and adaptive W-control circuitry 119 to control the size, i.e. the gate width, of the converter's power MOSFETs. The V_{control} signal, which is used to set the converter's output voltage, may comprise an analog signal or a digital code corresponding to a desired output voltage. To maximize converter efficiency, the same V_{control} signal is also in a preferred embodiment used to determine, i.e. to set, the width of the power MOSFETs comprising voltage regulator 118. The same signal may be used to set bias currents and the converter's switching frequency if so desired. Since the voltage programmable switching regulator adjusts its operating characteristics, i.e. adapts its gate width, to the same V_{control} control signal controlling the regulator's programmable output voltage and the load current, then switching regulator 116 also constitutes an “adaptive” switching regulator.

In another embodiment made in accordance with this invention shown in circuit 120 of FIG. 5D, the voltage powering radio frequency power amplifier 122 is controlled by the voltage output of voltage regulator 121 in response to control signal V_{control}. At higher output voltages, the PA 122 dissipates more power and requires more current but operates at higher bandwidths, capable of transmitting data at higher data rates. At lower output voltages, the PA 122 dissipates less power and draws less current but operates at lower bandwidths, primarily useful for voice communication. In this manner bandwidth and communication data rate can be dynamically adjusted to minimize current consumption and maximize battery life when high data rate communication is not required.

Voltage regulator 121 comprises a switching regulator 123 with an adjustable output voltage and W-control circuitry 124 to control the size, i.e. the gate width, of the converter's power MOSFETs. The V_{control} signal, which is used to set the converter's output voltage, may comprise an analog signal or a digital code corresponding to a desired output voltage. To maximize converter efficiency, the V_{control} signal is also in a preferred embodiment used to determine, i.e. to set, the width of the power MOSFETs comprising voltage regulator 123. The same signal may be used to set bias currents and the converter's switching frequency if so desired. Since the voltage programmable switching regulator adjusts its operating characteristics, i.e. adapts its gate width, to the same V_{control} control signal controlling the regulator's programmable output voltage and the load current, then switching regulator 123 also constitutes an “adaptive” switching regulator.

In another embodiment of this invention shown in circuit 155 of FIG. 5E a control signal V_{control} is used to determine the output voltage of voltage regulator 126 driving load 127 whose load current I_{OUT} is exclusively or primarily a function of said output voltage V_{OUT} comprising a known current-voltage relationship I_{OUT}=f(V_{OUT}). Voltage regulator 126 comprises a switching regulator 128 with an adjustable output voltage and W-control circuitry 129 to control the size, i.e. the gate width, of the converter's power MOSFETs. The V_{control} signal, which is used to set the converter's output voltage, may comprise an analog signal or a digital code corresponding to a desired output voltage. The same signal may be used to set bias currents and the converter's switching frequency if so desired. To maximize converter efficiency, the V_{control} signal is also used to determine, i.e. to set, the width of the power MOSFETs comprising voltage regulator 128. Since the voltage programmable switching regulator adjusts its operating characteristics, i.e. adapts its gate width, to the same V_{control} control signal controlling the regulator's programmable output voltage and the load current, then switching regulator 126 also constitutes an “adaptive” switching regulator.

The programmable switching regulator with adaptive power MOSFETs disclosed herein therefore comprises at least one control signal that determines the load current and also sets the gate widths of the converter's switching power MOSFETs. The same signal may also be used to set bias currents and the converter's switching frequency if so desired.

Programmable Boost Voltage Regulator with Dual-State Power MOSFET

In one implementation of a programmable voltage regulator with a dual-state adaptive power MOSFET made in accordance with this invention, synchronous boost converter 200 shown in FIG. 6 includes a main power MOSFET pair 201A and a second power MOSFET pair 201B, inductor 204, capacitor 205, PWM controller 210, break-before-make circuit 209, low-side gate buffer 216, floating gate buffer 215, low-side W-control enable logic gate 207B, and floating W-control enable logic gate 206B.

Main MOSFET pair 201 A includes low-side N-channel power MOSFET 203A having a MOSFET gate width W_{1LS} and floating P-channel synchronous power MOSFET 202A having a MOSFET gate width W_{1SR}. Floating MOSFET 202A includes P-N junction diode 208 and in parallel with its drain-to-source terminals. Second MOSFET pair 201B includes low-side N-channel power MOSFET 203B having a MOSFET gate width W_{2LS} and floating P-channel synchronous rectifier power MOSFET 202B having a MOSFET gate width W_{2SR}. Synchronous rectifier MOSFET 202B also includes a P-N junction diode in parallel with its drain-to-source terminals also illustrated as PN junction 208. P-N junction diodes intrinsic to low-side MOSFETs 203A and 203B include parallel P-N junction diodes which remain reverse biased during normal converter operation and are therefore not shown. Floating MOSFETs 202A and 202B may comprise N-channel MOSFETs with appropriate changes in gate buffer 215, e.g. using bootstrap gate drive techniques well known in the art.

PWM controller 210 includes an adjustable reference voltage V_{ref} for setting the target output voltage of the converter V′_{OUT} controlled by the output of digital-to-analog D/A converter 211 in response to digital serial interface 214 and corresponding to a ROM code contained within ROM 212. The output of serial interface 214 also controls decoder 213 driving the W-control enable logic gates 206B and 207B. Under normal operation, main MOSFETs 202A and 203A switch in alternating fashion to control the average current in inductor 204 and the output voltage across capacitor 205. At higher currents, MOSFETs 202A and 202B conduct in tandem and switch in alternating fashion with low-side MOSFETs 203A and 203B to control the average current in inductor 204 and the output voltage across capacitor 205.

BBM circuit 209 prevents shoot-through conduction by insuring floating synchronous rectifier MOSFETs 202A and 202B do not conduct any substantial current simultaneous to low-side MOSFETs 203A and 203B. Gate buffers 215 and 216 drive floating and low-side MOSFETs 202A and 203A respectively comprising push-pull stage 201A. The output of buffered AND gates 206B and 207B drive floating MOSFETs 202B and low-side MOSFET 203B respectively, comprising push-pull stage 201B. During the break-before-make interval established by BBM circuit 209 when no power MOSFET conducts substantial current, P-N diode 208 must conduct the current in inductor 204. A Schottky diode, not shown, may be optionally included in parallel with diode 208 to reduce the current and charge storage in P-N junction. Schottky diodes typically exhibit lower stored charge and smaller forward voltage drops during conduction than similarly area P-N junction diodes.

The pulse width, i.e. the on-time of low-side MOSFET 203A, is adjusted in response to voltage feedback signal V_{FB} from the converter's output using PWM control circuit 210. Under some conditions, especially at higher load currents, the pulse width and the corresponding on-time of low-side MOSFET 203B is also adjusted to conduct in tandem with MOSFET 203A in response to voltage feedback signal V_{FB} from the converter's output using PWM control circuit 210. Some portion of the time when MOSFET 203A is not conducting, synchronous rectifier MOSFET 202A is conducting. Under certain circumstances, especially at higher load currents, synchronous rectifier MOSFET 202B may be driven to conduct in tandem with synchronous rectifier MOSFET 202A.

Pulse width control may comprise fixed frequency pulse-width-modulation techniques or variable frequency control. PWM controller 210, made in accordance with techniques well known in the art typically includes an error amplifier, a clock or ramp generator, a PWM comparator, and a voltage reference. Together, the pulse-width output of PWM controller 210, combined with the outputs of decoder 213, control the switching operation of push-pull MOSFET bridges 201A and 201B.

Digital communication interface 214 receives digital commands and controls the output voltage of regulator 200 through digital-to-analog converter 211. Digital communication interface 214 may comprise any serial communication protocol such as I²C, SPI bus, simple serial control or S²Cwire interface, advanced simple serial control or AS²Cwire interface, or any alternative serial protocol. Parallel or other digital communication protocols may also be used. The digital code is converted into an analog signal or voltage using D/A converter 211. The output of D/A converter 211 controls the output voltage of converter 200 by providing or otherwise controlling the reference voltage of PWM controller 210. The digital code is converted into an analog parameter representing the output voltage of converter 200 using a conversion table stored in associated ROM 212.

The same digital code input to A/D converter 211 is also employed to control the size, i.e. the gate width, of power MOSFETs driving inductor 204 within switching regulator 200, specially power MOSFETs 201A, 201B, 203A, and 203B, through decoder 213. The output of decoder 213 includes the floating synchronous-rectifier and low-side gate width control signals WC_{SR} and WC_{LS} respectively, thereby controlling which MOSFETs are switching in response to the signals from PWM controller 209 and which are not. As shown, MOSFETs 202A and 203A always conduct in response to PWM controller 209. MOSFETs 202B and 203B, however, conduct conditional to the state of the WC_{SR} and WC_{LS} signals coming from the output of decoder 213 in response to the digital control signal from interface 210.

Assuming inductor current I_{L} has an average value that increases relatively monotonically with the output voltage V_{OUT} of regulator 200, and the output voltage of converter corresponds to a specific digital code, then indirectly the digital code also controls the average output current. For example, a 3-bit digital input code 001 corresponds to a reference voltage V_{ref1} and corresponds to an output voltage V_{OUT1} and an average load current I_{L1}±ΔI_{L} proportional to inductor current. Similarly a higher code 010 corresponds to higher reference voltage V_{ref2}, a higher output voltage V_{OUT2}, and a higher load and inductor current I_{L2}±ΔI_{L}. Accordingly, V_{OUT3}>V_{OUT2}>V_{OUT1}>V_{OUT0} and in corresponding fashion the inductor and load current increase monotonically, i.e. where I_{L3}>V_{L2}>V_{L1}>V_{L0}. For codes 000 through 011 corresponding to output voltages V_{OUT1} to V_{OUT3}, only push-pull stage 201A is switching and output stage 201B is biased off meaning the total synchronous rectifier MOSFET gate width switching is W_{1SR} and the total low-side MOSFET gate width switching is W_{1LS}. For codes 100 through 111 corresponding to output voltages V_{OUT4} to V_{OUT7}, both push-pull stages 201A and 201B are switching meaning the total synchronous-rectifier MOSFET gate width switching is (W_{1SR}+W_{2SR}) and the total low-side MOSFET gate width switching is (W_{1LS}+W_{2LS}). Such an example is illustrated in the following logic truth table:

| Code | V_{ref} | V_{OUT} | ~I_{L} | Switching | Sync-rect W | Low-side W |
|---|---|---|---|---|---|---|
| 000 | V_{ref0} | V_{OUT0} | I_{L0} + ΔI_{L} | 201A switching | W_{1SR} | W_{1LS} |
| 001 | V_{ref1} > V_{ref0} | V_{OUT1} > V_{OUT0} | I_{L1} + ΔI_{L} > I_{L0} | (201B off) | | |
| 010 | V_{ref2} > V_{ref1} | V_{OUT2} > V_{OUT1} | I_{L2} + ΔI_{L} > I_{L1} | | | |
| 011 | V_{ref3} > V_{ref2} | V_{OUT3} > V_{OUT2} | I_{L3} + ΔI_{L} > I_{L2} | | | |
| 100 | V_{ref4} > V_{ref3} | V_{OUT4} > V_{OUT3} | I_{L4} + ΔI_{L} > I_{L3} | Both | W_{1SR} + W_{2SR} | W_{1LS} + W_{2LS} |
| 101 | V_{ref5} > V_{ref4} | V_{OUT5} > V_{OUT4} | I_{L5} + ΔI_{L} > I_{L4} | 201A & 201B | | |
| 110 | V_{ref6} > V_{ref5} | V_{OUT6} > V_{OUT5} | I_{L6} + ΔI_{L} > I_{L5} | switching | | |
| 111 | V_{ref7} > V_{ref6} | V_{OUT7} > V_{OUT6} | I_{L7} + ΔI_{L} > I_{L6} | | | |

As shown an increase in output voltage V_{OUT} corresponds to an increase in the average inductor current I_{L} within a tolerance range ΔI_{L}. Including the tolerance range the function is not necessarily purely monotonic, but relatively monotonic on average. The key requirement is that half-bridge stage 201A must comprise sufficiently large MOSFETs, namely gate widths W_{1SR} and W_{1LS} to operate normally and with good regulation at a maximum inductor current of I_{L3}+ΔI_{L}. The current tolerance ΔI_{L} is the change in the inductor current associated with normal and expected statistical variability in the load, power supply input, operating temperature, and component parameters.

In the example shown the relative gate widths of the synchronous-rectifier and low-side MOSFETs increase to W_{1SR}+W_{2SR} and W_{1LS}+W_{2LS} at the code 011 corresponding to an output voltage V_{OUT3}. The transition for the low-side and synchronous rectifier MOSFETs from small to large gate width switching devices need not occur at the same input code or output voltage. For example if the duty factor calculated from PWM control circuit 210 were also used to influence the operation of gate width decoder 213, the relative gate width could also be adjusted depending on the relative on-time, i.e. pulse width, of the converter.

For example if V_{OUT}>>V_{batt} and the inductor current is high, the synchronous rectifier is on and conducting for a relatively short duration but the low-side device is on for a high percentage of each cycle. In such a case, it is beneficial to increase the low-side gate width to the larger W_{1LS}+W_{2LS} size because it is conducting for a longer duration even though the synchronous rectifier MOSFET remains switching with a smaller total gate width of only W_{1SR}. Conversely if V_{batt}≈V_{OUT} and the inductor current is high, the synchronous device is on and conducting for a relatively long duration but the low-side MOSFET is on for a short time of each cycle. In such a case, it is beneficial to increase the synchronous rectifier gate width to the larger W_{1SR}+W_{2SR} size and continue to operate the low-side MOSFET with a smaller total gate width of only W_{1LS}. This behavior is illustrated in the table below:

In a converter operating near 50% duty factor, i.e. when the output voltage is half the input voltage, at high currents both synchronous rectifier and low-side MOSFETs utilize the maximum gate width device.

| Code | V_{OUT} | ~I_{L} | V_{OUT} >> V_{batt} | V_{OUT} ≈ 2 V_{batt} | V_{batt} ≈ V_{OUT} |
|---|---|---|---|---|---|
| 000 | V_{OUT0} | I_{L0} + ΔI_{L} | Any duty factor D | | |
| 001 | V_{OUT1} > V_{OUT0} | I_{L1} + ΔI_{L} > I_{L0} | W_{1SR} only, W_{1LS} only | | |
| 010 | V_{OUT2} > V_{OUT1} | I_{L2} + ΔI_{L} > I_{L1} | | | |
| 011 | V_{OUT3} > V_{OUT2} | I_{L3} + ΔI_{L} > I_{L2} | | | |
| 100 | V_{OUT4} > V_{OUT3} | I_{L4} + ΔI_{L} > I_{L3} | D → 100% | D → 50% | D → 0% |
| 101 | V_{OUT5} > V_{OUT4} | I_{L5} + ΔI_{L} > I_{L4} | W_{1SR} only | W_{1SR} + W_{2SR} | W_{1SR} + W_{2SR} |
| 110 | V_{OUT6} > V_{OUT5} | I_{L6} + ΔI_{L} > I_{L5} | W_{1LS} + W_{2LS} | W_{1LS} + W_{2LS} | W_{1LS} only |
| 111 | V_{OUT7} > V_{OUT6} | I_{L7} + ΔI_{L} > I_{L6} | | | |

In such an embodiment, adjusting the relative gate widths of the synchronous rectifier and low-side MOSFETs depending on the duty factor is not an important consideration. Instead the smallest MOSFET gate widths W_{1HS} and W_{1LS} continue to switch and all other devices are turned off.

### Benefit of Adaptive Gate Width Technique in Boost Regulators

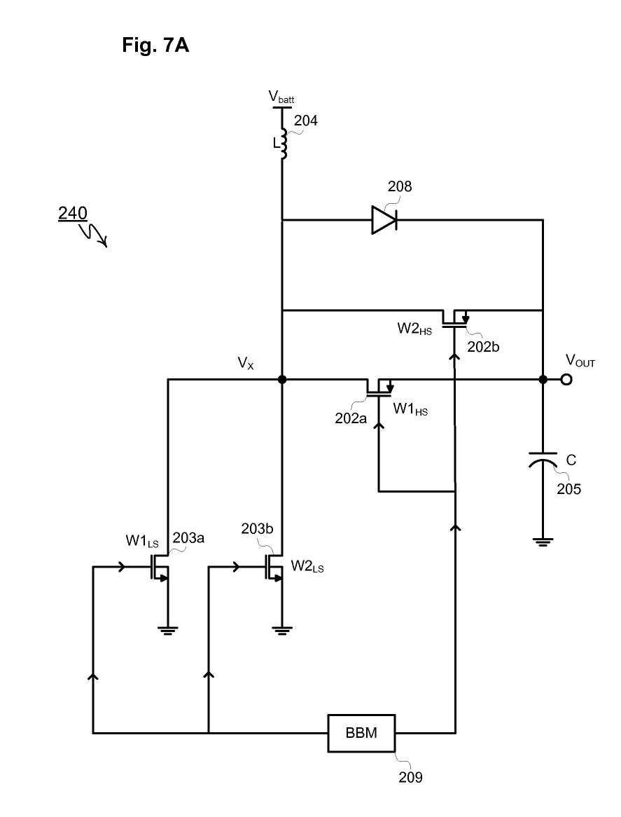

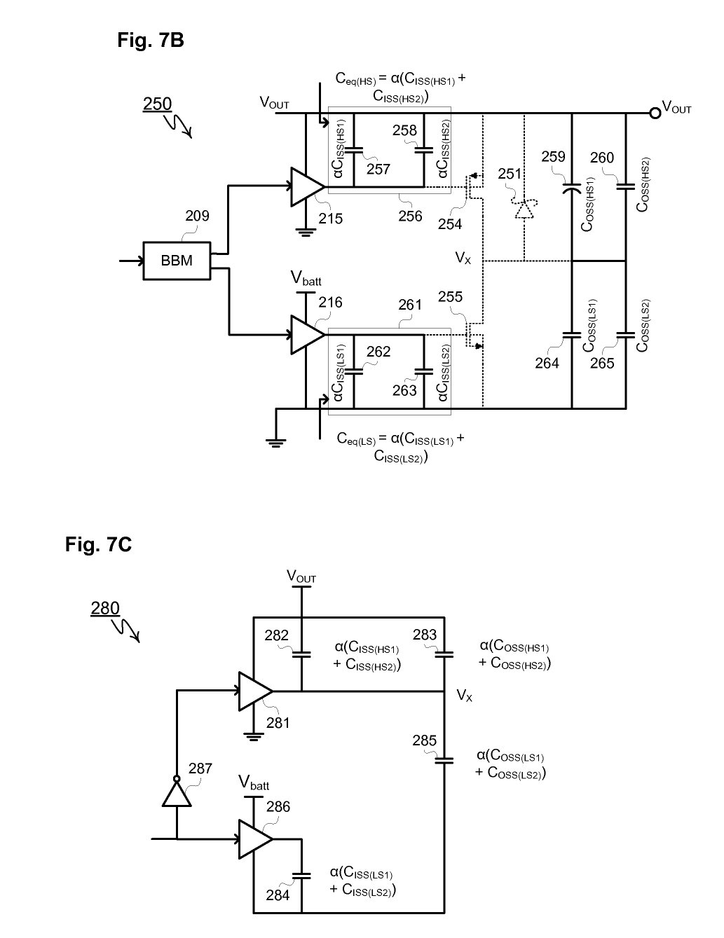

The efficiency improvement offered by changing the portion of a power MOSFET's gate width switching occurs because of reduced gate drive losses. Synchronous boost regulator 200 operating at high currents has a simplified equivalent circuit 240 as illustrated in FIG. 7A where neglecting the gate buffers, BBM circuit 209 continuously drives both low side MOSFETs 203A and 203B in switch mode operation, and also drives floating synchronous rectifier MOSFETs 202A and 202B out-of-phase with the low side MOSFETs. Together all four MOSFETs control the current in inductor 204.

The large signal AC equivalent model 250 for the switching circuit is shown in FIG. 7B comprising BBM circuit 209, floating gate buffer 215 driving the gate of synchronous rectifier MOSFET 254 from V_{OUT} to ground, and low-side gate buffer 216 driving the gate of MOSFET 255 from ground to V_{batt}. MOSFET 254 represents the parallel combination of synchronous rectifier MOSFETs 202A and 202B including gate capacitance 256, the parallel sum of input capacitances 257 and 258 amplified by a variable gain factor α used to simply account for the effect of voltage gain on the MOSFET's gate to drain capacitance, also known to those skilled in the art as the Miller feedback effect. Because of this variable gain factor α, in switching operation the input capacitance C_{eq(SR)} can be three to ten times greater than the sum of the small signal input capacitances C_{ISS(SR1)}+C_{ISS(SR2)}. Synchronous rectifier MOSFET 254 also includes the parallel combination of its C_{OSS} drain-to-source capacitances 259 and 260. At low-voltages, the total synchronous rectifier drain capacitance, not amplified by the variable gain factor α, is negligible compared to the input capacitance.

MOSFET 255 represents the parallel combination of low-side MOSFETs 203A and 203B including gate capacitance 261, the parallel sum of input capacitances 262 and 263 amplified by a variable gain factor α used to simply account for the effect of voltage gain on the MOSFET's gate to drain capacitance, also known to those skilled in the art as the Miller feedback effect. Because of this variable gain factor α, in switching operation the input capacitance C_{eq(LS)} can be three to ten times greater than the sum of the small signal input capacitances C_{ISS(LS1)}+C_{ISS(LS2)}. Low-side MOSFET 255 also includes the parallel combination of its C_{OSS} drain-to-source capacitances 264 and 265. At low-voltages, the total synchronous rectifier drain capacitance, not amplified by the variable gain factor α, is negligible compared to the input capacitance.

With two different power supply sources V_{batt} and V_{OUT} used for driving the MOSFETs' gates and load, the equivalent circuit of a synchronous boost converter can be approximated by circuit 280 in FIG. 7C, including synchronous rectifier gate buffer 281, synchronous rectifier input capacitance 282, synchronous rectifier output capacitance powered by V_{OUT} and low-side gate buffer 286, low-side input capacitance 284, powered by V_{batt} and low-side output capacitance 285 powered by V_{OUT}. Since the gain factor α varies with voltage, it is easier to approximate the switching regulator's power loss using gate charge.

By neglecting the affect of the output capacitances 283 and 285, the losses at high current include the synchronous rectifier power MOSFET power loss in a boost converter can be approximated by the relation

$${P}_{loss ( SR )} = {I}_{L}^{2} ( {R}_{DS ( SReq )} ) \cdot \frac{D}{1 - D} + ( {Q}_{G ( SR 1 )} + {Q}_{G ( SR 2 )} ) \cdot {V}_{GS ( SR )} f$$

where R_{DS(SReq)} is the parallel combined resistance of MOSFETs 202A and 202B and Q_{G(SR1)} and Q_{G(SR2)} describes the gate drive losses associated with capacitances 257 and 258 or equivalent capacitance 282. In circuit 240, gate drive V_{GS(SR)} is equal to V_{OUT}.

The low-side power MOSFET power loss can be approximated by the relation

$${P}_{loss ( LS )} = {I}_{L}^{2} ( {R}_{DS ( LSeq )} ) \cdot \frac{1}{1 - D} + ( {Q}_{G ( LS 1 )} + {Q}_{G ( LS 2 )} ) \cdot {V}_{GS ( LS )} f$$

where R_{DS(LSeq)} is the parallel combined resistance of MOSFETs 203A and 203B and Q_{G(LS1)} and Q_{G(LS2)} describes the gate drive losses associated with capacitances 262 and 263 or equivalent capacitance 284. In circuit 240, gate drive V_{GS(LS)} is equal to V_{batt}.

The total power loss of the dual state switching regulator with all MOSFETs switching is the sum of the low-side and synchronous rectifier power loss as given by:

$${P}_{loss} = {I}_{L}^{2} ( \begin{matrix}( {R}_{DS ( SReq )} ) \cdot \frac{D}{1 - D} + \\ ( {R}_{DS ( LSeq )} ) \cdot \frac{1}{( 1 - D )}\end{matrix} ) + ( \begin{matrix}{Q}_{G ( LS 1 )} + {Q}_{G ( LS 2 )} + \\ ( {Q}_{G ( SR 1 )} + {Q}_{G ( SR 2 )} ) \frac{1}{1 - D}\end{matrix} ) \cdot {V}_{batt} f$$

Unless special floating gate drive circuits are employed, the gate drive of the synchronous rectifier MOSFETs is powered by V_{OUT} not by V_{batt}, whereby in the above equation the parenthesized term Q_{G(SR1)}+Q_{G(SR2)} is multiplied by V_{batt}/(1−D) which is equivalent to V_{OUT}.

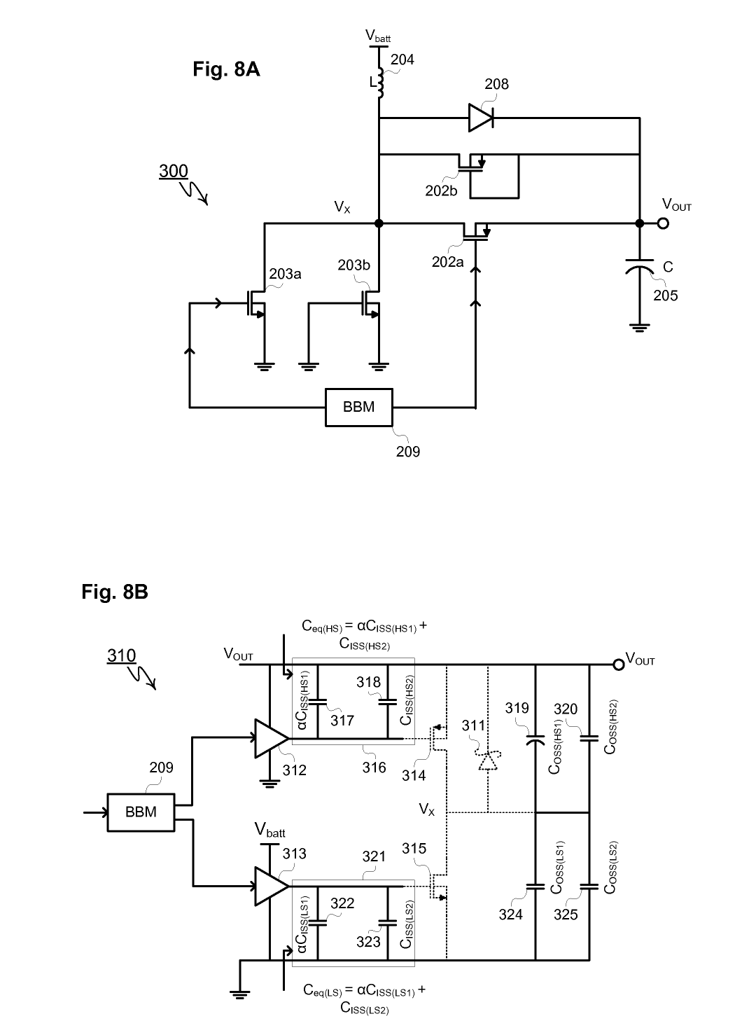

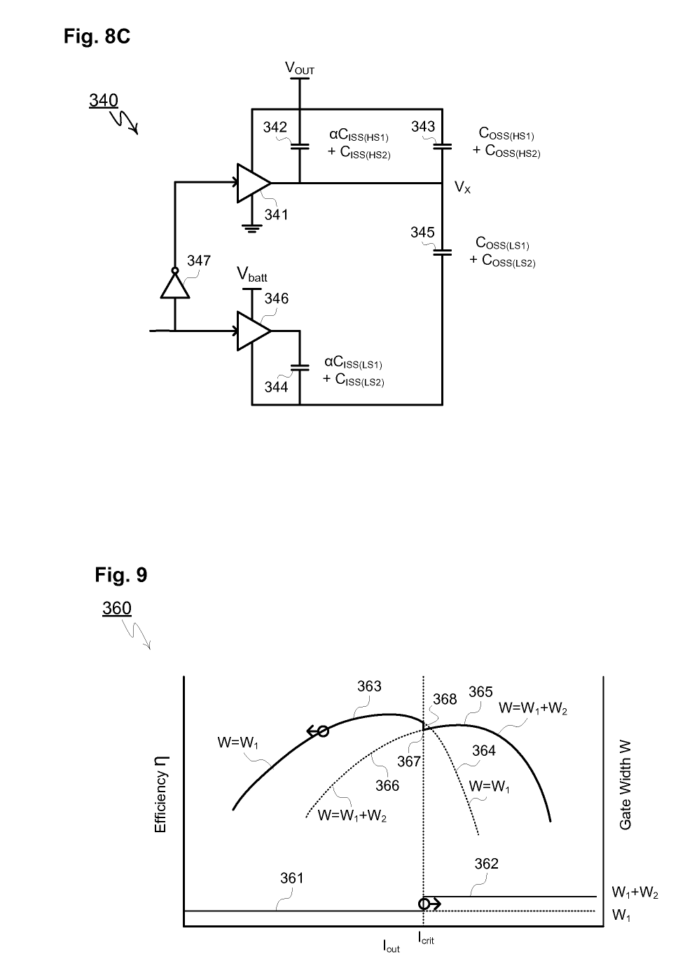

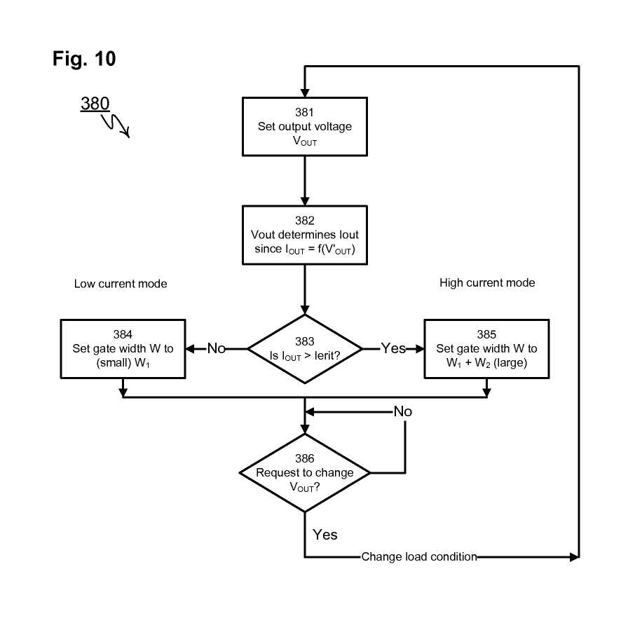

Synchronous boost regulator 200 operating at low currents has a simplified equivalent circuit 300 as illustrated in FIG. 8A where neglecting the gate buffers, in switch mode operation BBM circuit 209 continuously drives only synchronous rectifier MOSFET 202A and also drives low-side MOSFETs 203A out-of-phase with the MOSFET 202A. Unlike in circuit 240, MOSFETs 202B and 203B are biased into an off condition in circuit 300 and do not control the current in inductor 204.

The large signal AC equivalent model 310 for the switching circuit is shown in FIG. 8B comprising BBM circuit 209, synchronous rectifier gate buffer 312 driving the gate of MOSFET 314 from V_{OUT} to ground, and low-side gate buffer 313 driving the gate of MOSFET 315 from ground to V_{batt}. MOSFET 314 represents the conducting synchronous rectifier MOSFET 202A including gate capacitance 317 amplified by a variable gain factor α used to simply account for the effect of voltage gain on the MOSFET's gate to drain capacitance, or Miller capacitance. Capacitance 318 represents the input, i.e. the gate to-drain capacitance associated with off MOSFET 202B. Because this gate is not being driven by buffer 312, capacitance 318 is not amplified by variable gain factor α. The total input capacitance 316 is therefore lower than gate capacitance 256 of FIG. 7B. C_{OSS} drain-to-source capacitances 319 and 320 correspond to both MOSFETs 202A and 202B. At low-voltages, however, the total synchronous rectifier drain capacitance, not amplified by the variable gain factor α, is negligible compared to the input capacitance.

MOSFET 315 represents the low-side MOSFETs 203A including gate capacitance 322 amplified by a variable gain factor α associated with the Miller feedback effect. Input capacitance 323 is not amplified by variable gain factor α and therefore total input capacitance 321 is lower than 261 in FIG. 7B. The parallel combination of C_{OSS} drain-to-source capacitances 324 and 325 represent the output capacitance of MOSFETs 203A and 203B. At low-voltages, the total synchronous rectifier drain capacitance, not amplified by the variable gain factor α, is negligible compared to the input capacitance.

With two different power supply sources V_{batt} and V_{OUT} used for driving the MOSFETs' gates and load, the equivalent circuit of a synchronous boost converter can be approximated by circuit 340 in FIG. 8C, including gate buffer 341, synchronous rectifier input capacitance 342, synchronous rectifier output capacitance 343, low-side input capacitance 344, and low-side output capacitance 345. Since the gain factor α varies affects only a portion of capacitances 342 and 344, the total capacitance and corresponding gate charge is reduced.

By neglecting the affect of the output capacitances 343 and 345, the losses at low current of the synchronous rectifier power MOSFET can be approximated by the relation

$${P}_{loss ( SR )} \approx {I}_{L}^{2} ( {R}_{DS ( SR 1 )} ) \cdot \frac{D}{1 - D} + ( {Q}_{G ( SR 1 )} ) \cdot {V}_{GS ( SR )} f$$

where R_{DS(SR1)} is the resistance of MOSFET 202A and Q_{G(SR1)} describes the gate drive losses associated primarily with capacitance 257. In circuit 340, gate drive V_{GS(SR)} is equal to V_{OUT}, not V_{batt}.

Similarly, the low-side power MOSFET power loss can be approximated by the relation

$${P}_{loss ( LS )} \approx {I}_{L}^{2} ( {R}_{DS ( LS 1 )} ) \cdot \frac{1}{( 1 - D )} + ( {Q}_{G ( LS 1 )} ) \cdot {V}_{GS ( LS )} f$$

where R_{DS(LS1)} is the resistance of MOSFETs 203A and Q_{G(LS1)} describes the gate drive losses primarily associated with capacitances 262. In circuit 340, gate drive V_{GS(LS)} is equal to V_{batt}.

The total power loss of the switching regulator operating at lower currents is the sum of the low-side and synchronous rectifier power loss as given by:

$${P}_{loss} = {I}_{L}^{2} ( \begin{matrix}( {R}_{DS ( SR 1 )} ) \cdot D + \\ ( {R}_{DS ( LS 1 )} ) \cdot \frac{1}{( 1 - D )}\end{matrix} ) + ( \begin{matrix}{Q}_{G ( LS 1 )} + \\ {Q}_{G ( SR 1 )} \frac{1}{( 1 - D )}\end{matrix} ) \cdot {V}_{batt} f$$

Compared to the power loss equation for the device of FIG. 7A, the device has a higher resistance but lower gate charge in this operating mode.

The effect of the higher resistance is to increase conduction losses at any given current but reduce gate drive related switching losses. Plotting the two equations on graph 360 of FIG. 9, the larger device having a switching gate width of W₁+W₂ shown by curve 366 and 365 operates to higher currents but drops in efficiency rapidly at lower current outputs. The smaller device with only gate width W₁ switching shown by curves 363 and 364 is shifted left toward lower currents having higher peak efficiency than the larger device, but at lower currents. Graph 360 reveals that no one size device can operate over the full range of currents optimally. Curve section 364 illustrates for small devices a rapid drop in efficiency at high currents. Conversely, section 366 illustrates that large devices lose efficiency at low currents because they suffer from too much capacitance.

Instead of trying to compromise with a single device, FIG. 9 illustrates switching operation of a single device with gate width W₁ shown by curve 361 up to some value of inductor current I_{crit} and then switching the gate width to W₁+W₂ above that current as shown by 362. The overall efficiency curve then becomes a combination of curve 363 below I_{crit} and curve 365 above I_{crit} with a transition in between. Specifically the efficiency of curve 365 drops down to point 367 at I_{crit} then jumps up to a higher efficiency 368 at lower currents automatically and dynamically by using the smaller device. The overall effect is that high efficiency can be achieved over wider range of currents using the adaptive gate drive technique than a single device can achieve.

In converter 200, the control signal from interface 214 may also be used to decrease the clock frequency f with PWM block 210 to a lower value, especially when the regulator is supplying load current in the milliamp range and below. Also at even lower load currents, e.g. in the microampere range, the output of interface 214 or of D/A 211 can be used to lower the DC bias currents in various current sources used within PWM block 210. Combining lower frequency operation and lower bias currents with adaptive gate drive will further extend the high efficiency range to current lower than that shown by curve 363.

### Algorithmic Approach to Programmable Gate Drive

Using logic, a microcontroller, or mixed signal design techniques, adaptive gate drive requires some decision-making to occur dynamically in order to maximize a switching regulator's efficiency in real time. As stated previously however, it is difficult to react sufficiently fast to changes in load current without losing regulation. In switching regulators with programmable output voltages driving an electrical load that exhibits a monotonically increases in current corresponding to higher output voltages, the control input can be used to optimize the converter's gate width.

In algorithm 380 the first step 381 is to set the output voltage V_{OUT} to some desired value V′_{OUT}. In step 382, the output current is established, i.e. set, in respect to the output voltage. The current may be calculated or measured. If the load current has no relationship to the output voltage, this method cannot be used. In step 383, the measured, calculated or target load current I_{OUT} is compared to some critical transition current I_{crit}. If the target current is above the critical value, the gate widths of the switching MOSFETs are set in step 385 to W₁+W₂. If the current is less than the critical value, the gate widths are set to the smaller value W₁. Once set, the converter will continue to operate in this mode until the target output voltage V′_{OUT} is changed in step 386.

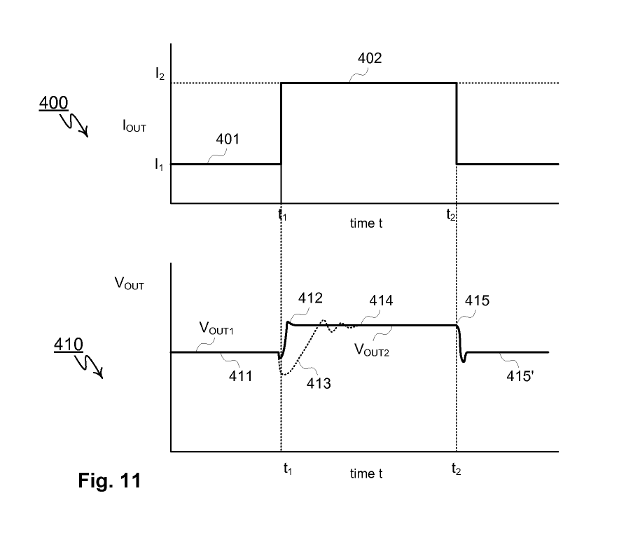

For example as shown in graph 410 of FIG. 11 if at time t₁ a change in the output voltage from V_{OUT1} to V_{OUT2} occurs and the load current shown in corresponding graph 400 jumps from I₁ to I₂, a fixed gate width switching regulator takes time to react, especially if the power MOSFET is undersized. During this adjustment period as the current increases from 401 to 402, the output voltage momentarily dips 413 in response and may take several switching cycles to recover till a stable voltage 414 is reached.

Any attempt to measure a current and adjust the duty factor or increase the gate width as a result of the measurement takes time, during which period regulation 413 suffers. By automatically changing the gate width in tandem with a desired change in output voltage, the voltage transient 412 of the adaptive gate width regulator is greatly reduced and the recovery time is shortened. Decreasing the output voltage and load current at time t₂ is less problematic and produces a minimal transient 415. So programmable gate drive for varying the width of the power MOSFETs comprising a switching regulator made in accordance with this invention improves step load response, especially if the output voltage target is the cause of the step load current transient.

Programmable Boost Voltage Regulator with Multi-State Power MOSFET

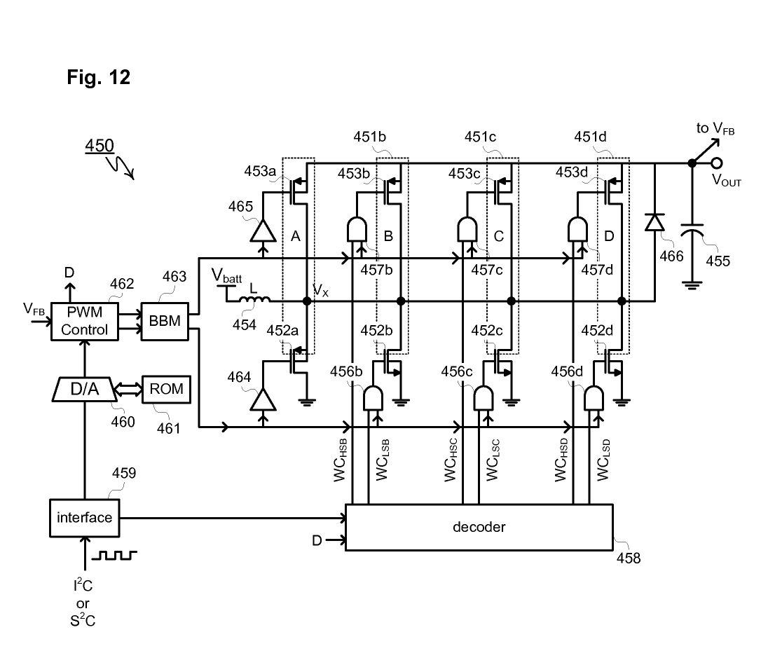

In another implementation of a programmable voltage regulator with a multi-state programmable power MOSFET made in accordance with this invention, synchronous boost converter 450 shown in FIG. 12 includes a main power MOSFET push-pull pair 451A and a number of other power MOSFET push-pull pairs 451B, 451C and 451D, along with inductor 454, capacitor 455, PWM controller 462, break-before-make circuit 463, low-side gate buffer 464, synchronous rectifier gate buffer 465, low-side gate-width-control enable logic gates 456B, 456C, 456D, synchronous rectifier gate-width-control enable logic gates 457B, 457C and 457D, said gates controlled by decoder circuit 458.

Main MOSFET pair 451A includes low-side N-channel power MOSFET 453A having a MOSFET gate width W_{1LS} and synchronous rectifier P-channel power MOSFET 452A having a MOSFET gate width W_{1SR}. Synchronous rectifier MOSFET 453A includes P-N a junction diode, not shown, in parallel with its drain-to-source terminals. Second MOSFET pair 451B includes low-side N-channel power MOSFET 452B having a MOSFET gate width W_{2LS} and synchronous rectifier P-channel power MOSFET 452B having a MOSFET gate width W_{2SR}. Synchronous rectifier MOSFET 453B includes P-N junction diode, not shown, in parallel with its drain-to-source terminals. Third MOSFET pair 451C includes low-side N-channel power MOSFET 452C having a MOSFET gate width W_{3LS} and synchronous rectifier P-channel power MOSFET 452C having a MOSFET gate width W_{3SR}. Synchronous rectifier MOSFET 453C includes a P-N junction diode, not shown, in parallel with its drain-to-source terminals. Fourth MOSFET pair 451D includes low-side N-channel power MOSFET 452D having a MOSFET gate width W_{4LS} and synchronous rectifier P-channel power MOSFET 453D having a MOSFET gate width W_{4SR}. Low-side MOSFET 452D includes a P-N junction diode 470D, not shown, in parallel with its drain-to-source terminals. Collectively these parasitic diodes represent the P-N junction diodes intrinsic to synchronous rectifier MOSFETs 453A, 453B, 453C and 453D and comprise diode 466. Diode 466 may also comprise a Schottky diode shunting the parasitic P-N junction diodes. Synchronous rectifier MOSFETs 453A, 453B, 453C and 453D may comprise N-channel MOSFETs with appropriate changes in gate buffer 465, e.g. using bootstrap gate drive techniques well known in the art.

PWM controller 462 includes an adjustable reference voltage V_{ref} for setting the target output voltage of the converter V′_{OUT} controlled by the output of digital-to-analog D/A converter 460 in response to digital serial interface 459 and corresponding to a ROM code contained within ROM 461. The output of serial interface 459 also controls decoder 458 driving synchronous rectifier gate-width-control enable logic gates 457 with control signals WC_{SRB}, WC_{SRC} and WC_{SRD} and drives low-side gate-width-control enable logic gates 456 with control signals WC_{LSB}, WC_{LSC} and WC_{LSD}.

Under normal operation, main MOSFETs 452A and 453A switch in alternating fashion to control the average current in inductor 454 and the output voltage across capacitor 455. At higher currents, low-side MOSFETs 452A and 452B conduct in tandem and switch in alternating fashion with synchronous rectifier MOSFETs 453A and 453B to control the average current in inductor 454 and the output voltage across capacitor 455. At even higher currents, some combination of low-side MOSFETs 452A, 452B and 452C conduct in tandem and switch in alternating fashion with synchronous rectifier MOSFETs 453A, 453B and 453C to control the average current in inductor 454 and the output voltage across capacitor 455. Finally at the highest currents, some combination of low-side MOSFETs 452A, 452B, 452C and 452D conduct in tandem and switch in alternating fashion with synchronous rectifier MOSFETs 453A, 453B, 453C and 453D to control the average current in inductor 454 and the output voltage across capacitor 455.

BBM circuit 463 prevents shoot-through conduction by insuring low-side MOSFETs 452A through 452D do not conduct any substantial current simultaneous to synchronous rectifier MOSFETs 453A through 453D. Gate buffers 464 and 465 drive low-side and synchronous rectifier MOSFETs 452A and 453A respectively comprising push-pull stage 451A. The output of buffered AND gates 456B and 457B drive low-side and synchronous rectifier MOSFETs 452B and 453B respectively, comprising push-pull stage 451B. The output of buffered AND gates 456C and 457C drive low-side and synchronous rectifier MOSFETs 452C and 453C respectively, comprising push-pull stage 451C. Finally, the output of buffered AND gates 456D and 457D drive low-side and synchronous rectifier MOSFETs 452D and 453D respectively, comprising push-pull stage 451D.

During the break-before-make interval established by BBM circuit 462 when no power MOSFET conducts substantial current, P-N diode 466 must conduct the current in inductor 454. An optional Schottky diode may be included to reduce the current and charge storage in P-N junction diode 466. Schottky diodes typically exhibit lower stored charge and smaller forward voltage drops during conduction than similarly area P-N junction diodes.

The pulse width, i.e. the on-time of low-side MOSFET 452A, is adjusted in response to voltage feedback signal V_{FB} from the converter's output using PWM control circuit 462. Under some conditions, especially at higher load currents, the pulse width and the corresponding on-time of synchronous rectifier MOSFETs 452B, 452C and 452D are in some combination also adjusted to conduct in tandem with MOSFET 452A in response to voltage feedback signal V_{FB} from the converter's output using PWM control circuit 462. Some portion of the time when MOSFET 452A is not conducting, synchronous rectifier MOSFET 453A is conducting. Under certain circumstances, especially at higher load currents, synchronous rectifier MOSFETs 453B, 453C and 453D may in some combination be driven to conduct in tandem with synchronous rectifier MOSFET 453A.

Pulse width control may comprise fixed frequency pulse-width-modulation techniques or variable frequency control. PWM controller 462, made in accordance with techniques well known in the art typically includes an error amplifier, a clock or ramp generator, a PWM comparator, and a voltage reference. Together, the pulse-width output of PWM controller 462, combined with the outputs of decoder 458, control the switching operation of push-pull MOSFET bridges 451A, 451B, 451C and 451D.

Digital communication interface 459 receives digital commands and controls the output voltage of regulator 450 through digital-to-analog converter 460. Digital communication interface 459 may comprise any serial communication protocol such as I²C, SPI bus, simple serial control or S²Cwire interface, advanced simple serial control or AS²Cwire interface, or any alternative serial protocol. Parallel or other digital communication protocols may also be used. The digital code is converted into an analog signal or voltage using D/A converter 460. The output of D/A converter 460 controls the output voltage of converter 450 by providing or otherwise controlling the reference voltage of PWM controller 462. The digital code is converted into an analog parameter representing the output voltage of converter 450 using a conversion table stored in associated ROM 461.

The same digital code input to A/D converter 460 is also employed to control the size, i.e. the gate width, of power MOSFETs driving inductor 454 within switching regulator 450, namely power MOSFET pairs 451A, 451B, 451C, and 451D, through decoder 458. The output of decoder 458 includes the synchronous rectifier and low-side gate width control signals WC_{HSB} through WC_{HSD} and WC_{LS} through WC_{LSD} respectively, thereby controlling which MOSFETs are switching in response to the signals from PWM controller 462 and which are not. As shown, MOSFETs 452A and 453A always conduct in response to PWM controller 462. Power MOSFETs 452B, 452C, 452D, 453B, 453C and 453D, however, conduct conditional to the state of the various WC_{SR} and WC_{LS} signals coming from the output of decoder 458 in response to the digital control signal from interface 459.

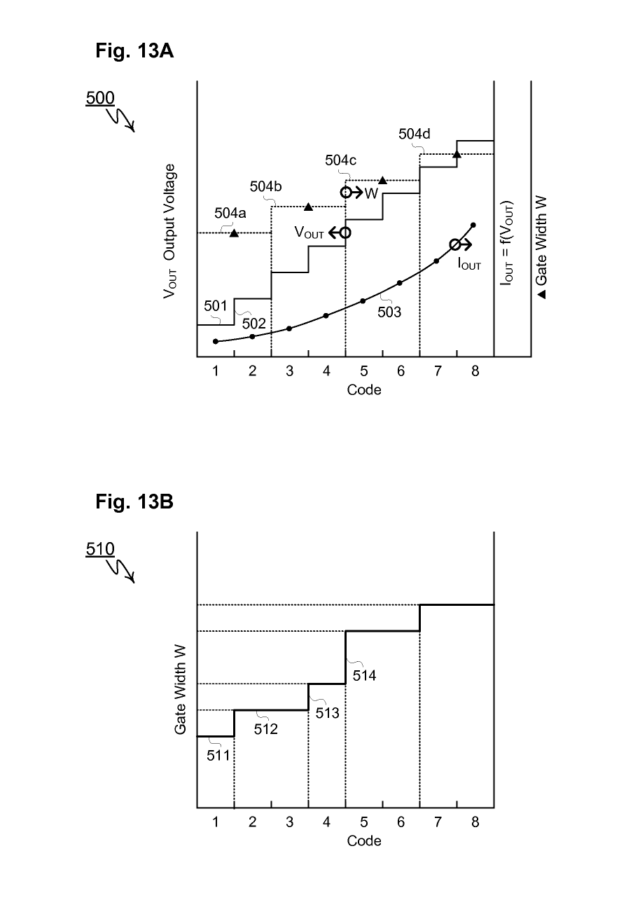

The size and gate width of power MOSFETs 452B, 452C, 452D, 453B, 453C and 453D may be identical or vary to facilitate any number of gate width combinations. For example in FIG. 13A an 8-bit code is used to illustrate eight different combinations 501 of V_{OUT} corresponding to eight different I_{OUT} load current combinations 503. As shown the step height 502 of voltage between any two states is even meaning the ROM code and D/A converter were configured for equal sized steps to produce a linear voltage characteristic for various sequential code combinations. Furthermore, the even incremental steps in gate width from gate width 504A in codes 1 and 2, up to a total gate width 504D for codes 7 and 8 mean that power MOSFETs 452B, 452C, 452D, and similarly 453B, 453C and 453D are of equal size. Despite the even increments 502 in output voltage, the current depends on the load characteristics. For example a RF power amplifier being powered by the programmable regulator may exhibit a linear relationship between current and voltage while light emitting diodes manifest an exponential characteristic at lower currents and a linear response at high currents.

Alternative combinations of gate widths are also possible. For example in gate width versus code of graph 510 in FIG. 13B, the gate width increments such as steps 513 and 514 are not in even amounts. Also as shown in graph 510, gate width 511 is unique to code 1 while codes 2 and 3 both correspond to the same gate width 512.

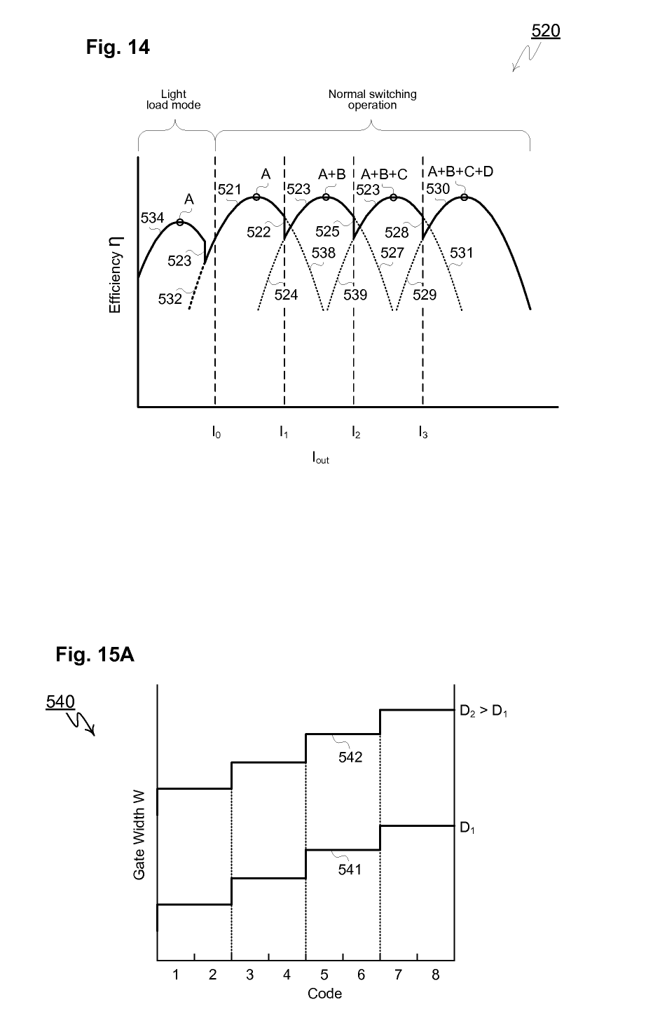

FIG. 14 illustrates the efficiency versus current characteristics of a multi-state programmable switching voltage regulator. As shown in graph 520, operation at currents greater than I₀ utilize fixed frequency pulse width modulation but vary the width of the MOSFET in accordance with the serial interface code. For example the curve 521 between I₀ and I₁ corresponds to the efficiency when only push-pull stage A is switching. Below the current I₀ the efficiency 532 drops due to excess switching losses and low delivered power. Above the current the efficiency 538 drops because push-pull stage A isn't large enough to carry higher currents.

To achieve improved efficiency at higher currents push-pull stages A+B participate in switching, conducting current and driving the regulator's inductor 454. At current I₁ the decoder forces transition 522 which decreases efficiency abruptly to curve 523 from curve 521. At even higher currents push-pull stages A+B+C participate in switching, conducting current and driving the regulator's inductor 454. At current I₂ the decoder forces transition 525 which decreases efficiency abruptly to curve 526 from curve 523. At the highest currents push-pull stages all four stages, A+B+C+D, participate in switching, conducting current and driving the regulator's inductor 454. At current I₃ the decoder forces transition 528 which decreases efficiency abruptly to curve 530 from curve 526. Curve 530 represents the maximum current capability of the regulator. Because of the programmed switching of the gate widths the circuit never operates in a regime represented by curves 532, 524, 538, 539, 529 and 531.

At currents below I₀ fixed frequency PWM operation exhibits too many switching losses to achieve good light load efficiency. At transition 533, the circuit commences variable frequency operation allowing the period as well as the on time to vary and resulting in efficiency curve 534. During light load, the gate width corresponding to push-pull bridge A is employed, although even smaller gate widths may be used. Moreover, while graph 520 illustrates an orderly transition from push-pull stages comprising section A to A+B to A+B+C to A+B+C+D with increasing current, other combination may be inserted including A+B+D or A+C+D or for very small devices operating at very low currents only buffer C or D may suffice so long that half-bridge A includes into own enable AND gate.

Programming Gate Width with Duty Factor

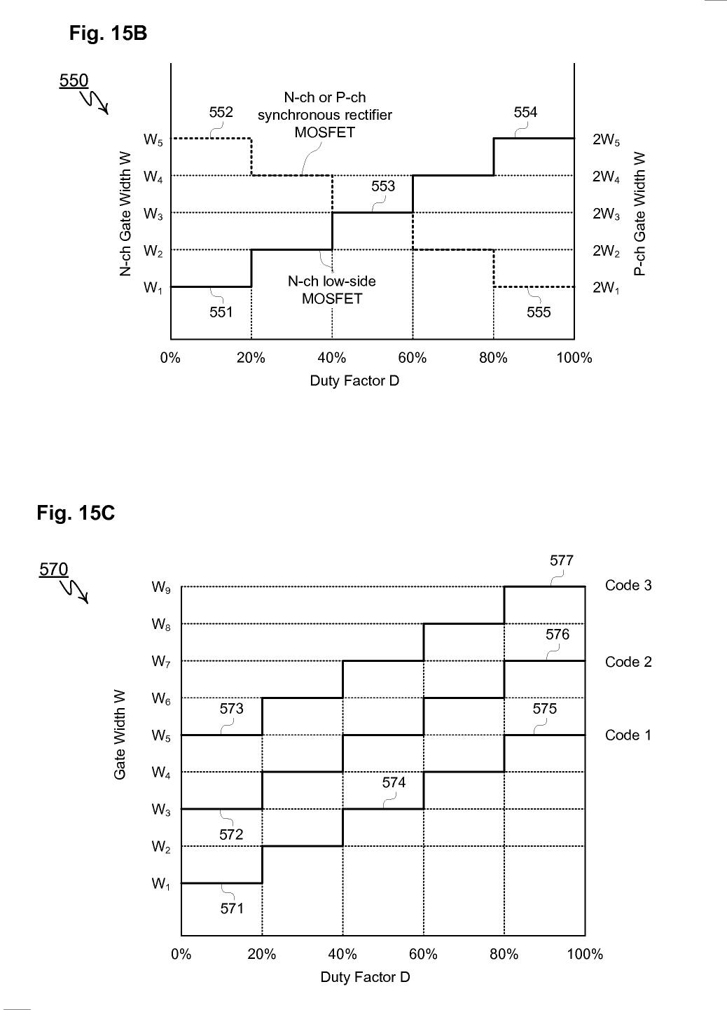

As described previously, along with its output voltage and current, a converter's duty factor may affect the optimum gating of power MOSFETs. In gate width graph 540 of FIG. 15A, curve 541 represents the gate width of a push-pull stage as a function of the digital input code for a duty factor of approximately D₁. At a higher duty factor D₂, a larger gate width may be required at any given code condition as shown by curve 542.

Another possible implementation is to program the MOSFET width of the synchronous rectifier MOSFET and the synchronous rectifier MOSFET as a function of duty factor but in inverse relation. As shown in graph 550 of FIG. 15B, as the duty factor increases the gate width of the low side N-channel MOSFET increases from W₁, i.e. curve 551, to W₃ for curve 553, to finally W₅ shown by curve 554.

With increasing duty factor, the gate width of the P-channel synchronous rectifier MOSFET decreases from 2W₅ at section 552, to 2W₃ in section 553, to finally 2W₁ in section 555, a reciprocal relationship to the synchronous rectifier device. If an N-channel MOSFET is used as a synchronous rectifier device, the gate widths should be roughly one-half the size of the comparable current P-channel.

This concept can be extended to include different output voltages and current ranges as shown in graph 570 of FIG. 15C where the gate width increases in proportion to duty factor D. For low current code 1 the gate width dependence on duty factor D varies from width 571 to 574 and finally to 575.

For medium currents and code 2 the gate width dependence on duty factor D varies from width 572 to 576 where width 572 is greater than 571. At even higher currents given by code 3 the gate width dependence on duty factor D varies from width 573 to 577 where width 573 is greater than 572 and width 577 is greater than 576. In this way maximum efficiency can be achieved for any given current and input to output voltage ratio.

### Regulator Control Implementation

Aside from its input power, the disclosed switching regulator responds to two electrical signals, one comprising feedback from the regulator's output, the other the control input used to program the output voltage and set the power MOSFET gate widths. Using analog circuitry to modulate the converter's pulse width, feedback from the output is generally the output voltage V_{OUT} fed back into the modulator circuit as an analog signal V_{FB}. The control interface may however comprise a digital command or an analog signal.

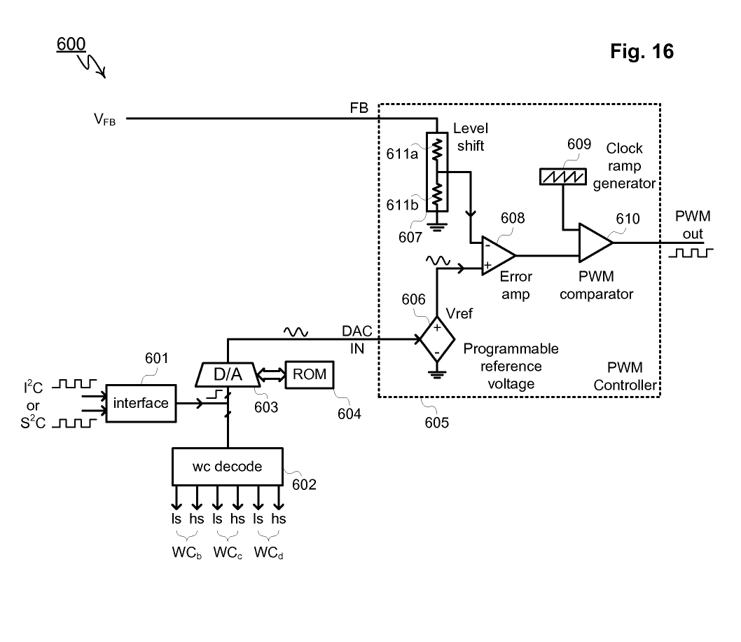

In control implementation 600 shown in FIG. 16, PWM control circuit 605 modulate the pulse width of a “PWM OUT” signal in response to feedback input “FB” and control input “DAC IN”. The PWM OUT signal is in turn used to control the switching of power MOSFETs made in accordance with this invention. PWM controller 605 contains a number of conventional elements including level shifter 607, error amplifier 608, and clock ramp generator 609. Voltage reference 606 exhibits a stable temperature-insensitive voltage V_{REF}. Unlike normal fixed output converters, voltage V_{REF} output from voltage reference 606 is adjustable and dynamically programmable in real time, responding to an analog signal present on the DAC IN pin of control circuit 605.

The DAC IN signal is an analog voltage or current output from digital-to-analog converter 603 responding to the output of digital control interface 601. The digital interface may comprise any serial or parallel input such I₂C, simple serial control S₂C, advanced simple serial control AS²C, SPI bus, RS232, IEEE488, or any number of digital interface communication protocols. The output of digital interface 601 is a digital parallel word 4 bits, 8 bits, 16 bits or 32 bits wide subsequently input into D/A converter 603, which in combination with ROM code 604 outputs a voltage or current used to set the V_{REF} reference voltage 606 within PWM controller 605. In this manner the reference voltage V_{REF} is controlled by the digital control interface 601 in response to its input.

This reference voltage V_{REF} comprises one input to error amplifier 608. The feedback signal V_{FB} level shifted by resistor divider 607 comprising resistors 611A and 611B comprises the second input V_{FB}′ to error amplifier 608. The output of error amplifier 608 represents the difference or error between the two signals V_{FB}′ and V_{REF}. The magnitude of error amplifier's output increases whenever V_{REF} is greater than V_{FB}′. The magnitude of error amplifier's output decreases whenever V_{REF} is less than V_{FB}′. The magnitude of error amplifier's output remains at zero or some nominal DC voltage whenever V_{REF} is approximately equal to V_{FB}′. In a preferred embodiment, the value of V_{REF} under dynamic control from the digital interface changes slowly compared to the rate of change in feedback signal V_{FB}′.

The output of error amplifier 608 feeds one input of PWM comparator 610. This signal is compared to a second ramp signal comprising a saw-tooth wave of either a fixed or varying duration output from clock ramp generator 609. The ramp may comprise a fixed slope when implementing “voltage mode” control or maybe varied in proportion to current in the regulator's inductor using “current mode” control. Resistors 611A and 611B are adjusted during construction to produce a nominal voltage V_{FB}′≈ V_{REF} whenever the output is operating at a steady state and maintaining a target output voltage V_{OUT}. The pulse width D of a Buck or synchronous Buck converter in fixed frequency operation under such a stable condition will remain steady at D=V_{OUT}/V_{batt}.

If the output should drop below the target value, the output of error amplifier 609 increases to a higher voltage taking a longer duration for ramp 609 to reach error voltage and flip the state of PWM comparator 610. The pulse width repeated each cycle in thereby lengthened, which in turn increases the current in the converter's inductor, driving the converter's output voltage back up to its nominal value. Conversely, if the output should rise above the target value, the output of error amplifier 609 decreases to a lower voltage taking a shorter duration for ramp 609 to reach error voltage and flip the state of PWM comparator 610. The pulse width repeated each cycle in thereby shortened, which in turn decreases the current in the converter's inductor, driving the converter's output voltage back down to its nominal value. By using negative feedback from signal V_{FB}, a targeted output voltage V_{OUT} can be maintained and well regulated.

Changing the control input to interface 601 allows a user or the system to change the value of V_{REF} and therefore after some time the converter to adjust its nominal pulse width and the steady state output voltage to be changed to a new value. The regulator is therefore capable of programming its output voltage to as many different distinct values as the digital interface and D/A converter 603 provides. In some instances D/A converter may receive its input directly from digital logic without the need for a serial to parallel interface conversion of circuit 601. For example D/A converter 603 may be contained within a baseband or applications processor and used to set the voltage powering an RD power amplifier or the brightness of one or more LEDs.

Regardless of the source of the digital information controlling D/A converter 603, in a switching regulator made in accordance with this invention, the same digital information is also used to set the state of the digital outputs of gate width control decoder 602, labeled as WC decode. As shown its outputs include control for a low-side LS and a synchronous rectifier power MOSFET pair for three stages WC_{B}, WC_{C}, and WC_{D} corresponding to portions of the gate widths of the low-side power MOSFET and the floating synchronous rectifier MOSFETs. Stage A is assumed to be always switching. The number of stages or gate segments may be as few as two, i.e. stage A and stage B, four stages as shown, i.e. A, B, C and D, or as many stages as desired or practical.

In the manner described the digital signal controlling the reference voltage 606 and pulse width modulator 605 sets the output voltage of the switching regulator and also determines which portions of the power MOSFET gate widths are switching at any given output voltage. The regulator's power MOSFET gate widths therefore adapt to the output voltage. If the load current varies in proportion to the voltage, then the gate width can be adjusted in proportion the converter's current to achieve maximum efficiency and an optimal balance between gate drive losses and conduction losses.

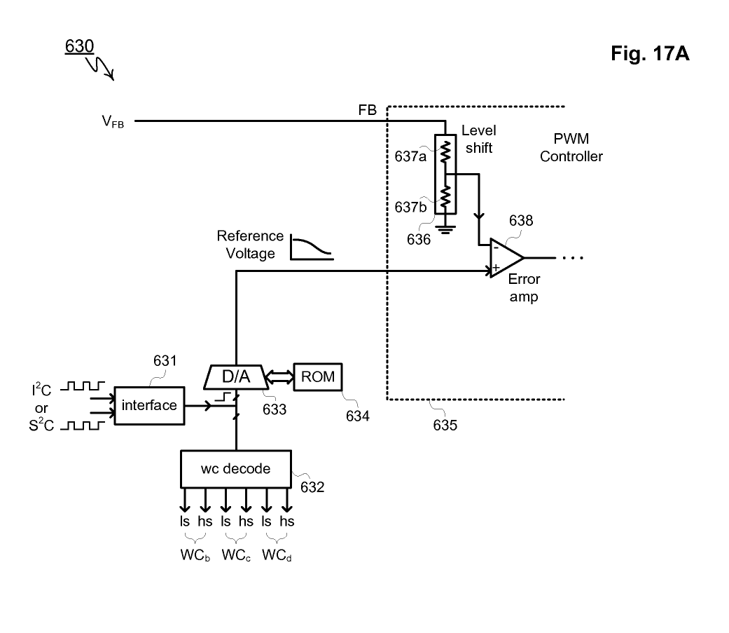

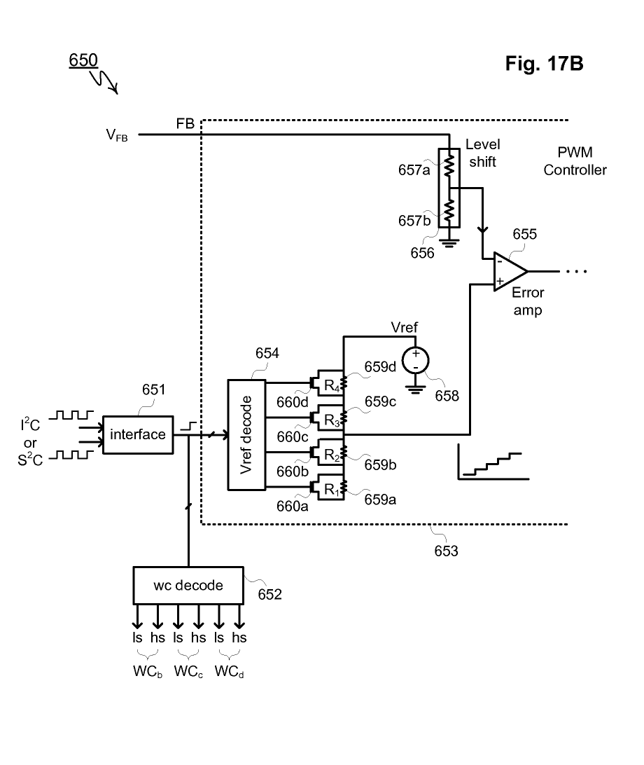

The control method 630 shown in FIG. 17A is similar to controller 600 of FIG. 16 except that the output of D/A converter 633 is the reference voltage fed directly into error amplifier 638. In the prior example the voltage reference 606 was internal to the modulator circuit and its value was set be the output of the D/A converter. In this example, the voltage reference within converter 633 replaces V_{REF} 606, i.e. its output is the reference voltage. Otherwise all the other components are identical including interface 631, gate width decoder 632, level shifter 636 and error amplifier 638. The ramp generator and PWM comparator within modulator circuit 635 are not shown for simplicities sake.

In the control method 650 of FIG. 17B, PWM controller 653 contains its own resistor ladder D/A converter feeding the input to error amplifier 655. The converter includes a fixed voltage reference 658 which may be implemented as a bandgap circuit a resistor divider comprising resistors 659A through 659D, with corresponding shunt MOSFETs 660A through 660D controlled by V_{REF} decoder circuit 654. The digital input to V_{REF} decoder 654 is the same input as the input to gate width decoder 652 which in the example shown is the output of digital interface 651. For any digital input V_{REF} decoder 654 turns some combination of MOSFETs 660 on and off shorting out portions of resistor ladder 660 and thereby changing the resistor divider ratio of fixed voltage reference V_{REF} 658. The adjustable output is fed into error amplifier 655 and compared to the feedback signal V_{FB}′. The feedback signal V_{FB}′ represents the output voltage feedback signal V_{FB} scaled by level shifter 656 comprising resistors 657A and 657B. As shown the same digital information programming the resistor ladder D/A converter within PWM modulator 653 also controls the gate width decoder 652. While three output pairs are illustrated the output of the WC decoder 652 may comprise as few as one output pair B or as many as beneficial.

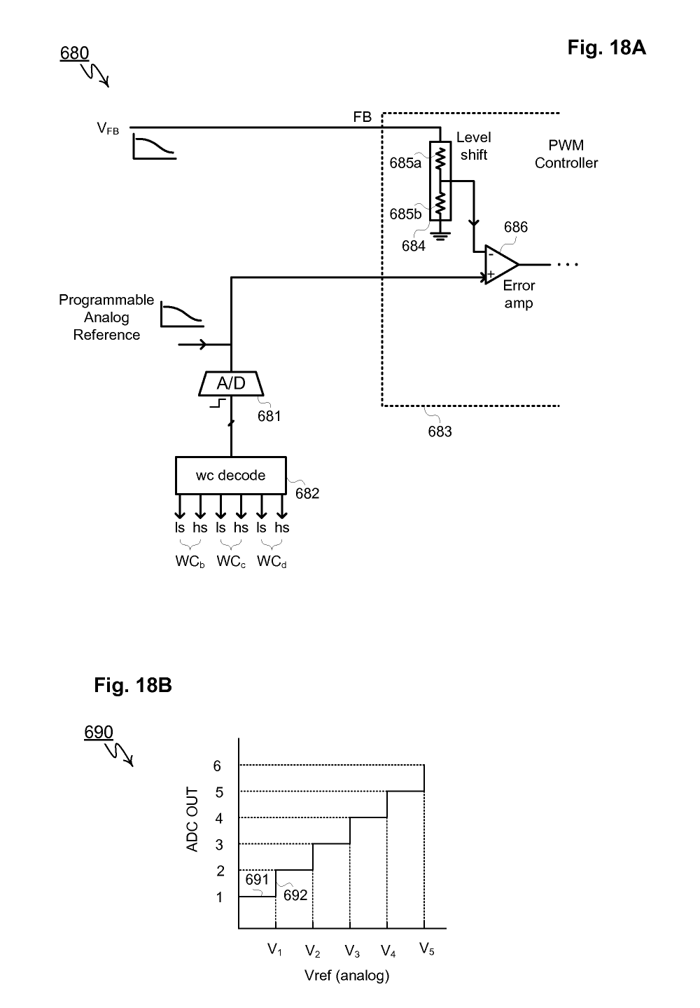

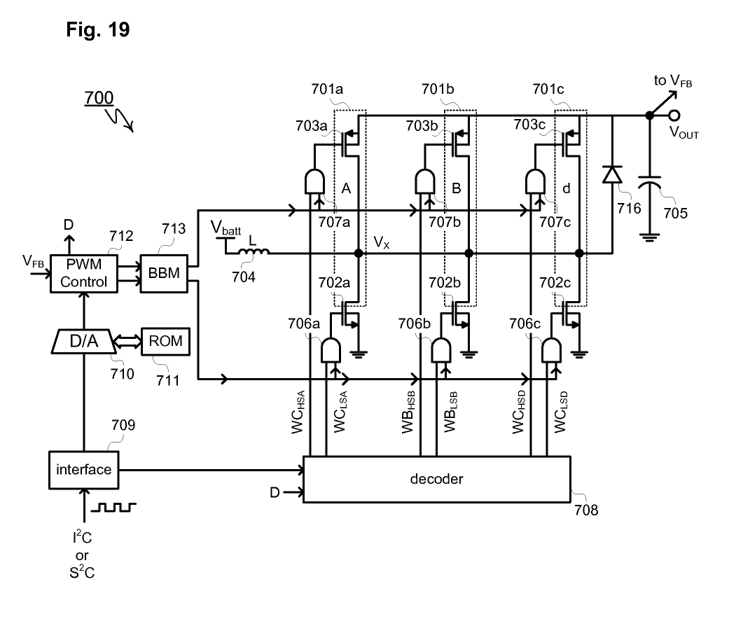

Control circuit 680 shown in FIG. 18A lacks a digital interface. Instead of using digital programming of the output voltage, control of PWM modulator 683 is achieved using an analog reference voltage, not a digital code. This analog voltage is a reference voltage to which error amplifier 686 compares the feedback signal V_{FB}′ coming from level shifter 684. Increasing the value of this analog V_{REF} increases the output voltage of the regulator. Since the control signal is an analog voltage however, it cannot directly control digital gate width decoder 682.

Instead, the analog reference voltage is also fed into the input of an A/D converter 681 in order to represent the analog value by some equivalent digital word or code. The output of A/D converter 681 in turn provides the input to gate width decoder 682 used to control which power MOSFET gate portions are switching or biased off. The accuracy of data converter 681 is not so critical since only a few combinations of gate widths are required to substantially improve the regulator's efficiency. Fort example in decoder graph 690 shown in FIG. 18B, the x-axis represents the analog V_{REF} input voltage to the converter while the y-axis illustrates an arbitrary digital code used to instruct decoder 682 which power MOSFET gates are switching and which ones are biased off. In this manner the same adaptive gate width control can be applied to a programmable switching regulator even when its control input is an analog signal, not digital control.

In FIG. 19, another implementation of a programmable voltage regulator with a multi-state programmable power MOSFET is generally designated 700. Voltage regulator 700 shares many of the components described previously for voltage regulator 450 of FIG. 12. In the case of voltage regulator 700, however it may be appreciated that all of the synchronous rectifiers 703 and all of the low-side switches 702 operate under control of decoder 708. This allows voltage regulator 700 to operate with any combination of synchronous rectifiers 703 and low-side switches 702. For example, voltage regulator 700 may operate with synchronous rectifier 702a disabled and synchronous rectifiers 702b and 702c enabled.

Voltage regulator 700 is especially useful where the widths of synchronous rectifiers 703 and low-side switch 702 vary geometrically. Thus, synchronous rectifier 703c could be twice as wide as synchronous rectifier 703b which could, in turn, be twice as wide as synchronous rectifier 703a. Similarly, low-side switch 702c could be twice as wide as low-side switch 702b which could, in turn, be twice as wide as low-side switch 702a

By selectively enabling and disabling low-side switches 702 and synchronous rectifiers 703, this type of configuration allows voltage regulator 700 to support operation at 1W, 2W, 3W, 4W, 5W, 6W and 7W modes.

The following table shows a mapping between codes and switch states for this type of implementation:

| | Switch 1 | Switch 2 | Switch 3 |
|---|---|---|---|
| Code | (1 W) | (2 W) | (4 W) |
| 1 | ON | OFF | OFF |
| 2 | OFF | ON | OFF |
| 3 | ON | ON | OFF |
| 4 | OFF | OFF | ON |
| 5 | ON | OFF | ON |
| 6 | OFF | ON | ON |
| 7 | ON | ON | ON |

It should be appreciated that separate codes may be used to control the synchronous rectifiers 703 and low-side switches 702 thus further increasing the configurability of regulator 700. Regulator 700 may also have more or fewer than the three pairs of synchronous rectifiers 703 and low low-side switches 702. Finally, it should also be appreciated that regulator 700 (like all embodiments of the present invention) may have more (or fewer) synchronous rectifiers 703 than low low-side switches 702.

What is claimed is:

1. A step-up switching voltage regulator that comprises:
an inductor connected between an input voltage and a node Vx;
M low-side switches connected between the node Vx and a ground voltage where M is an integer greater than zero;
N synchronous rectifiers connected between the node Vx and an output node where N is an integer greater than zero and where at least one of M and N is greater than one;
an interface circuit that decodes a control signal to identify: 1) a subset (m) of the low-side switches, 2) a subset (n) of the synchronous rectifiers, and 3) a reference voltage V_{ref}; and
a control circuit connected to drive the synchronous rectifiers and low-side switches in a repeating sequence that includes:
an inductor charging phase where the low-side switches in the subset m are activated to connect the node Vx to the ground voltage; and
an inductor discharging phase where the synchronous rectifiers in the subset n are activated to connect the node Vx to the output node.

2. A step-up switching voltage regulator as recited in claim 1 where N is not equal to M.

3. A step-up switching voltage regulator as recited in claim 1 where N is equal to M.

4. A step-up switching voltage regulator as recited in claim 1 where the input signal is digitally encoded.

5. A step-up switching voltage regulator as recited in claim 1 where the control circuit is configured to modulate the duration of the inductor charging and discharging phases to maintain the output voltage of the step-up switching voltage regulator within a predetermined tolerance of a voltage that is proportional to the voltage V_{ref}.

6. A step-up switching voltage regulator as recited in claim 1 where the subsets m and n may be empty.

7. A step-up switching voltage regulator as recited in claim 1 where at least two low-side switches have different gate widths.

8. A step-up switching voltage regulator as recited in claim 1 where at least two synchronous rectifiers have different gate widths.

9. A step-up switching voltage regulator as recited in claim 1 wherein each synchronous rectifier (except the narrowest) is twice as wide as the next widest synchronous rectifier and where each low-side switch (except the narrowest) is twice as wide as the next widest low-side switch.

10. A method for operating a step-up switching voltage regulator that includes an inductor connected between an input voltage and a node Vx, M low-side switches connected between the node Vx and a ground voltage where M is an integer greater than zero; N synchronous rectifiers connected between the node Vx and an output node where N is an integer greater than zero and where at least one of M and N is greater than one, the method comprising:
decoding a control signal to identify: 1) a subset (m) of the low-side switches, 2) a subset (n) of the synchronous rectifiers, and 3) a reference voltage V_{ref};
driving the synchronous rectifiers and low-side switches in a repeating sequence that includes:
an inductor charging phase where the low-side switches in the subset m are activated to connect the node Vx to the ground voltage; and
an inductor discharging phase where the synchronous rectifiers in the subset n are activated to connect the node Vx to the output node.

11. A method as recited in claim 10 where N is not equal to M.

12. A method as recited in claim 10 where N is equal to M.

13. A method as recited in claim 10 where the input signal is digitally encoded.

14. A method as recited in claim 10 where the control circuit is configured to modulate the duration of the inductor charging and discharging phases to maintain the output voltage of the step-up switching voltage regulator within a predetermined tolerance of a voltage that is proportional to the voltage V_{ref}.

15. A method as recited in claim 10 where the subsets m and n may be empty.

16. A method as recited in claim 10 where at least two low-side switches have different gate widths.

17. A method as recited in claim 10 where at least two synchronous rectifiers have different gate widths.

18. A method as recited in claim 10 wherein each synchronous rectifier (except the narrowest) is twice as wide as the next widest synchronous rectifier and where each low-side switch (except the narrowest) is twice as wide as the next widest low-side switch.
